(19) United States
(12) Patent Application Publication
(10) Pub. No.: US 2015/0241676 A1
(43) Pub. Date: Aug. 27, 2015

(54) ZOOM LENS AND IMAGING APPARATUS

(71) Applicant: FUJIFILM Corporation, Tokyo (JP)

(72) Inventors: Daiki KOMATSU, Saitama-ken (JP); Toshihiro AOI, Saitama-ken (JP); Yasutaka SHIMADA, Saitama-ken (JP)

(21) Appl. No.: 14/628,599

(22) Filed: Feb. 23, 2015

(30) Foreign Application Priority Data
Feb. 26, 2014 (JP) 2014-034896

(51) Int. Cl. G02B 15/17; G03B 3/00

(52) U.S. Cl. CPC G02B 15/17; G03B 3/00

(57) ABSTRACT

A zoom lens essentially consists of positive first lens group, negative second lens group, negative third lens group, negative fourth lens group, and positive fifth lens group in this order from an object side. First and fifth lens groups are fixed with respect to an image plane, and second through fourth lens groups move in such a manner that a distance from each other changes when magnification is changed from a wide angle end to a telephoto end. First lens group essentially consists of 11th lens group having negative refractive power, 12th lens group having positive refractive power, and 13th lens group having positive refractive power in this order from the object side. 11th and 13th lens groups are fixed with respect to the image plane and 12th lens group moves during focusing. Further, the following conditional expression (1) is satisfied:

2.10<f12/f13<4.10 (1).

### CROSS-REFERENCE TO RELATED APPLICATIONS

The present application claims priority under 35 U.S.C. §119 to Japanese Patent Application No. 2014-034896, filed on Feb. 26, 2014. The above application is hereby expressly incorporated by reference, in its entirety, into the present application.

### BACKGROUND OF THE INVENTION

1. Field of the Invention

The present invention relates to a zoom lens used in an electronic camera, such as a digital camera, a video camera, a camera for broadcasting, and a camera for surveillance, and also to an imaging apparatus including the zoom lens.

2. Description of the Related Art

Japanese Unexamined Patent Publication No. 2011-081063 (Patent Document 1), Japanese Unexamined Patent Publication No. 2012-242766 (Patent Document 2) and International Patent Publication No. WO2013/031205 (Patent Document 3) are known about zoom lenses used in electronic cameras, such as a digital camera, a video camera, a camera for broadcasting, and a camera for surveillance. Especially, a zoom lens in Example 5 of Patent Document 1, a zoom lens in Example 4 of Patent Document 2, and a zoom lens in Patent Document 3 consist of five groups, and have high performance.

### SUMMARY OF THE INVENTION

In the zoom lenses of Patent Documents 1 and 2, a zoom lens having an ordinary angle of view and a high magnification ratio and a zoom lens having a wide angle of view and a low magnification ratio are included in examples. However, the zoom lenses are not regarded as small-sized light-weight zoom lenses, because the outer diameter of a first lens group is large or the total length is long. Further, the zoom lens of Patent Document 3 has a high magnification ratio, and the size of the zoom lens is sufficiently reduced. However, the zoom lens of Patent Document 3 does not have a wide angle of view.

In view of the foregoing circumstances, it is an object of the present invention to provide a high-performance zoom lens having a wide angle of view and a high magnification ratio while the size of the zoom lens is small and the weight of the zoom lens is light, and an imaging lens including the zoom lens.

A zoom lens of the present invention essentially consists of a first lens group having positive refractive power, a second lens group having negative refractive power, a third lens group having negative refractive power, a fourth lens group having negative refractive power, and a fifth lens group having positive refractive power in this order from an object side. The first lens group and the fifth lens group are fixed with respect to an image plane, and the second lens group, the third lens group and the fourth lens group move in such a manner that a distance from each other changes when magnification is changed from a wide angle end to a telephoto end. The first lens group essentially consists of an 11th lens group having negative refractive power, a 12th lens group having positive refractive power, and a 13th lens group having positive refractive power in this order from the object side. The 11th lens group and the 13th lens group are fixed with respect to the image plane and the 12th lens group moves during focusing. Further, the following conditional expression (1) is satisfied:

2.10<f12/f13<4.10 (1), where

f12: a focal length of the 12th lens group, and

f13: a focal length of the 13th lens group.

In the zoom lens of the present invention, it is desirable that the following conditional expression (2) is satisfied:

1.00<f13/f1<1.50 (2), where

f13: a focal length of the 13th lens group, and

f1: a focal length of the first lens group.

Further, it is desirable that the following conditional expression (3) is satisfied:

0.90<Z2/f1<1.40 (3), where

Z2: a movement amount of the second lens group from a wide angle end to a telephoto end, and

f1: a focal length of the first lens group.

Further, it is desirable that the following conditional expression (4) is satisfied:

−1.30<f11/f13<−0.68 (4), where

f11: a focal length of the 11th lens group, and

f13: a focal length of the 13th lens group.

Further, it is desirable that the following conditional expression (5) is satisfied:

−1.23<f11/f1<−0.80 (5), where

f11: a focal length of the 11th lens group, and

f1: a focal length of the first lens group.

Further, it is desirable that the following conditional expression (6) is satisfied:

5.10<f1/Yimg<10.00 (6), where

f1: a focal length of the first lens group, and

Yimg: a maximum image height.

Further, it is desirable that the following conditional expression (1-1) is satisfied:

2.20<f12/f13<3.80 (1-1).

Further, it is desirable that the following conditional expression (2-1) is satisfied. It is more desirable that the following conditional expression (2-2) is satisfied:

1.20<f13/f1<1.50 (2-1); and

1.20<f13/f1<1.30 (2-2).

Further, it is desirable that the following conditional expression (3-1) is satisfied:

1.10<Z2/f1<1.20 (3-1).

Further, it is desirable that the following conditional expression (4-1) is satisfied:

−1.00<f11/f13<−0.70 (4-1).

Further, it is desirable that the following conditional expression (5-1) is satisfied:

−1.22<f11/f1<−0.90 (5-1).

Further, it is desirable that the following conditional expression (6-1) is satisfied. It is more desirable that the following conditional expression (6-2) is satisfied:

6.10<f1/Yimg<10.00 (6-1); and

6.40<f1/Yimg<7.50 (6-2).

An imaging apparatus of the present invention includes the aforementioned zoom lens of the present invention.

The expression “essentially consists of” means that a lens or lenses essentially without refractive power, an optical element, such as a stop, a mask, a cover glass and a filter, other than lenses, a mechanism part, such as a lens flange, a lens barrel, an imaging device and a hand shake blur correction mechanism, and the like may be included besides the mentioned composition elements.

Further, the surface shape and the sign of the refractive power of the aforementioned lenses are considered in a paraxial region when an aspherical surface is included.

The zoom lens of the present invention essentially consists of a first lens group having positive refractive power, a second lens group having negative refractive power, a third lens group having negative refractive power, a fourth lens group having negative refractive power, and a fifth lens group having positive refractive power in this order from an object side. Further, the first lens group and the fifth lens group are fixed with respect to an image plane, and the second lens group, the third lens group and the fourth lens group move in such a manner that a distance from each other changes when magnification is changed from a wide angle end to a telephoto end. Further, the first lens group essentially consists of an 11th lens group having negative refractive power, a 12th lens group having positive refractive power, and a 13th lens group having positive refractive power in this order from the object side. Further, the 11th lens group and the 13th lens group are fixed with respect to the image plane and the 12th lens group moves during focusing, and the following conditional expression (1) is satisfied. Therefore, it is possible to provide a high-performance zoom lens having a wide angle of view and a high magnification ratio while the size of the zoom lens is small and the weight of the zoom lens is light:

2.10<f12/f13<4.10 (1).

Further, the imaging apparatus of the present invention includes the zoom lens of the present invention. Therefore, the imaging apparatus can obtain high image-quality images with wide angles of view and high magnification ratios.

### BRIEF DESCRIPTION OF THE DRAWINGS

FIG. 1 is a cross section illustrating the lens configuration of a zoom lens according to an embodiment of the present invention (also Example 1);

FIG. 2 is an optical path diagram of the zoom lens according to an embodiment of the present invention (also Example 1);

FIG. 3 is a cross section illustrating the lens configuration of a zoom lens in Example 2 of the present invention;

FIG. 4 is a cross section illustrating the lens configuration of a zoom lens in Example 3 of the present invention;

FIG. 5 is a cross section illustrating the lens configuration of a zoom lens in Example 4 of the present invention;

FIG. 6 is a cross section illustrating the lens configuration of a zoom lens in Example 5 of the present invention;

FIG. 7 is a cross section illustrating the lens configuration of a zoom lens in Example 6 of the present invention;

FIG. 8 is aberration diagrams of the zoom lens in Example 1 of the present invention;

FIG. 9 is aberration diagrams of the zoom lens in Example 2 of the present invention;

FIG. 10 is aberration diagrams of the zoom lens in Example 3 of the present invention;

FIG. 11 is aberration diagrams of the zoom lens in Example 4 of the present invention;

FIG. 12 is aberration diagrams of the zoom lens in Example 5 of the present invention;

FIG. 13 is aberration diagrams of the zoom lens in Example 6 of the present invention; and

FIG. 14 is a schematic diagram illustrating the configuration of an imaging apparatus according to an embodiment of the present invention.

### DESCRIPTION OF THE PREFERRED EMBODIMENTS

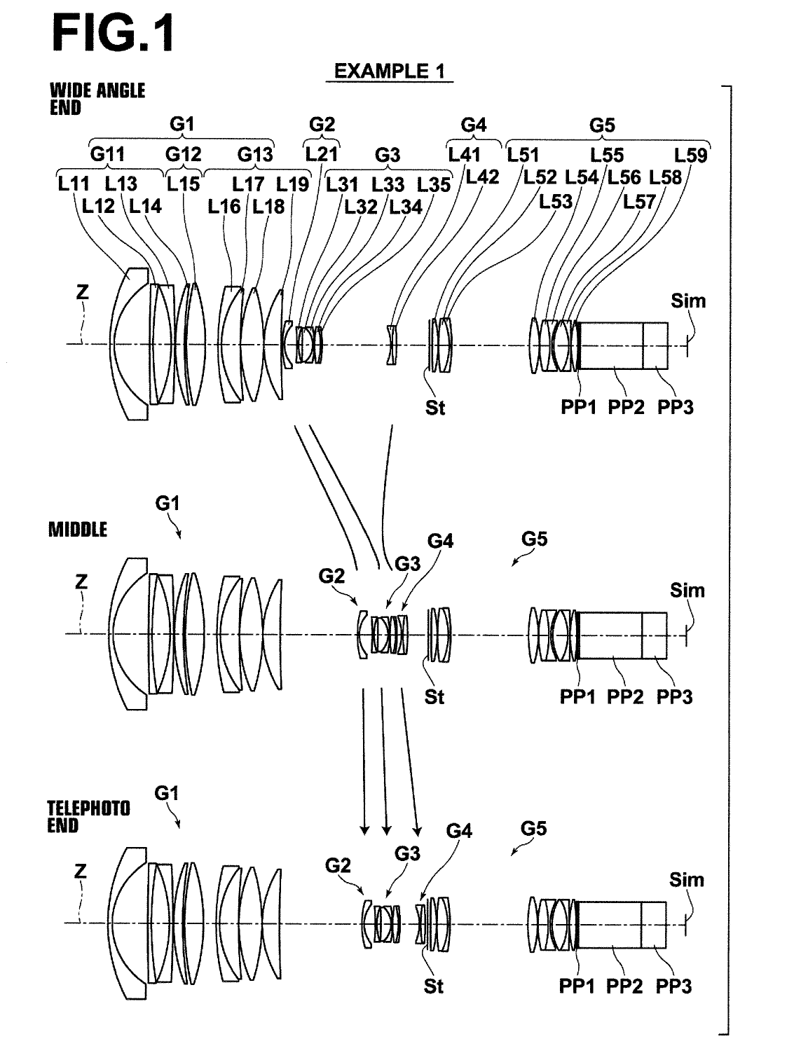

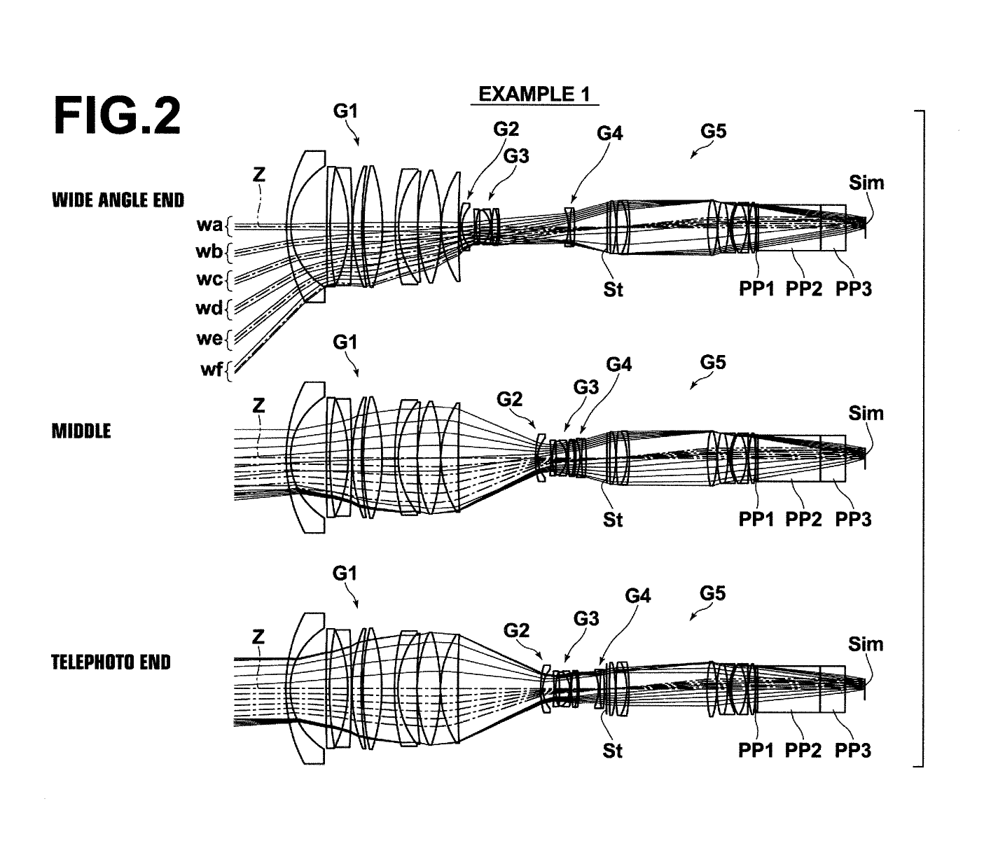

Next, embodiments of the present invention will be described in detail with reference to drawings. FIG. 1 is a cross section illustrating the lens configuration of a zoom lens according to an embodiment of the present invention. FIG. 2 is an optical path diagram of the zoom lens. Examples of the configuration illustrated in FIG. 1 and FIG. 2 are also the configuration of a zoom lens in Example 1, which will be described later. In FIG. 1 and FIG. 2, a left side is an object side, and a right side is an image side. In FIG. 1, a path of movement of each lens group is also illustrated. In FIG. 2, axial ray wa through ray wf at a maximum angle of view are also illustrated.

As illustrated in FIG. 1, this zoom lens consists of first lens group G1 having positive refractive power, second lens group G2 having negative refractive power, third lens group G3 having negative refractive power, fourth lens group G4 having negative refractive power, and fifth lens group G5 having positive refractive power in this order from an object side.

When this zoom lens is applied to an imaging apparatus, it is desirable to arrange a cover glass, a prism, and various filters, such as an infrared-ray-cut filter and a low-pass filter, between an optical system and image plane Sim based on the configuration of the apparatus part, on which the lens is mounted. Therefore, FIG. 1 and FIG. 2 illustrate an example in which parallel-flat-plate-shaped optical members PP1 through PP3, which are assumed to be these elements, are arranged between the lens system and image plane Sim,

This zoom lens is configured in such a manner that first lens group G1 and fifth lens group G5 are fixed with respect to an image plane, and second lens group G2, third lens group G3 and fourth lens group G4 move in such a manner that a distance from each other changes when magnification is changed from a wide angle end to a telephoto end.

Further, first lens group G1 consists of 11th lens group G11 having negative refractive power, 12th lens group G12 having positive refractive power, and 13th lens group G13 having positive refractive power in this order from the object side. Further, first lens group G1 is configured in such a manner that 11th lens group G11 and 13th lens group G13 are fixed with respect to an image plane and 12th lens group G12 moves during focusing.

When the whole zoom lens is configured as described above, it is possible to achieve high optical performance while the size of the zoom lens is small and the weight of the zoom lens is light. Further, when first lens group G1 is configured as described above, it is possible to reduce a fluctuation of an angle of view and fluctuations of aberrations during focusing.

Further, this zoom lens is configured to satisfy the following conditional expression (1). When the value does not exceed the upper limit of this conditional expression (1), it is possible to suppress the height of an axial marginal ray entering 13th lens group G13 at a telephoto end. Therefore, it is possible to reduce the size and the weight of 13th lens group G13 by suppressing the outer diameter of 13th lens group G13. Further, it is possible to secure excellent F-number Fno at the telephoto end. Further, when the value is not lower than the lower limit of conditional expression (1), it is possible to excellently correct a spherical aberration and curvature of field at the telephoto end while the configuration is advantageous to increasing an angle of view. Further, when the following conditional expression (1-1) is satisfied, more excellent characteristics are obtainable.

2.10<f12/f13<4.10 (1); and

2.20<f12/f13<3.80 (1-1), where

f12: a focal length of the 12th lens group, and

f13: a focal length of the 13th lens group.

In the zoom lens according to the embodiment of the present invention, it is desirable that the following conditional expression (2) is satisfied. When the value does not exceed the upper limit of this conditional expression (2), it is possible to suppress an increase in a distance between first lens group G1 and second lens group G2 at the telephoto end. Therefore, the configuration is advantageous to reducing the size and the weight of the zoom lens. Further, when the value is not lower than the lower limit of conditional expression (2), it is possible to prevent the refractive power of 13th lens group G13 from becoming too strong. Therefore, it is possible to excellently correct a spherical aberration and curvature of field at the telephoto end. When the following conditional expression (2-1) is satisfied, and more desirably, when conditional expression (2-2) is satisfied, more excellent characteristics are obtainable.

1.00<f13/f1<1.50 (2);

1.20<f13/f1<1.50 (2-1); and

1.20<f13/f1<1.30 (2-2), where

f13: a focal length of the 13th lens group, and

f1: a focal length of the first lens group.

Further, it is desirable that the following conditional expression (3) is satisfied. When the value does not exceed the upper limit of this conditional expression (3), it is possible to suppress a movement amount of second lens group G2. Therefore, the configuration is advantageous to reducing the size and the weight. Further, when the value is not lower than the lower limit of conditional expression (3), it is possible to prevent the refractive power of second lens group G2 from becoming too strong. Therefore, it is possible to reduce a fluctuation of aberrations during magnification change. Here, when the following conditional expression (3-1) is satisfied, more excellent characteristics are obtainable.

0.90<Z2/f1<1.40 (3); and

1.10<Z2/f1<1.20 (3-1), where

Z2: a movement amount of the second lens group from a wide angle end to a telephoto end, and

f1: a focal length of the first lens group.

Further, it is desirable that the following conditional expression (4) is satisfied. When the value does not exceed the upper limit of this conditional expression (4), it is possible to suppress the height of rays output from 11th lens group G11. As a result, it is possible to reduce the outer diameters of 12th lens group G12 and 13th lens group G13. Therefore, the configuration is advantageous to reducing the size and the weight. Further, when the value is not lower than the lower limit of conditional expression (4), it is possible to prevent the refractive power of 13th lens group G13 from becoming too strong. Therefore, it is possible to excellently correct a spherical aberration and curvature of field at the telephoto end. When the following conditional expression (4-1) is satisfied, more excellent characteristics are obtainable.

−1.30<f11/f13<−0.68 (4); and

−1.00<f11/f13<−0.70 (4-1), where

f11: a focal length of the 11th lens group, and

f13: a focal length of the 13th lens group.

Further, it is desirable that the following conditional expression (5) is satisfied. When the value does not exceed the upper limit of this conditional expression (5), it is possible to suppress the height of rays output from 11th lens group G11. As a result, it is possible to reduce the outer diameters of 12th lens group G12 and 13th lens group G13. Therefore, the configuration is advantageous to reducing the size and the weight. Further, when the value is not lower than the lower limit of conditional expression (5), it is possible to prevent the refractive power of 11th lens group G11 from becoming too weak. Therefore, it is possible to excellently correct a spherical aberration and curvature of field at the telephoto end. When the following conditional expression (5-1) is satisfied, more excellent characteristics are obtainable.

−1.23<f11/f1<−0.80 (5); and

−1.22<f11/f1<−0.90 (5-1), where

f11: a focal length of the 11th lens group, and

f1: a focal length of the first lens group.

Further, it is desirable that the following conditional expression (6) is satisfied. When the value does not exceed the upper limit of this conditional expression (6), it is possible to suppress the height of rays output from first lens group G1. As a result, it is possible to suppress an increase in a distance between first lens group G1 and second lens group G2 at the telephoto end. Therefore, the configuration is advantageous to reducing the size and the weight of the zoom lens. Further, when the value is not lower than the lower limit of conditional expression (6), it is possible to excellently correct a spherical aberration, astigmatism and curvature of field at the telephoto end. Here, when the following conditional expression (6-1) is satisfied, and more desirably, when the following conditional expression (6-2) is satisfied, more excellent characteristics are obtainable.

5.10<f1/Yimg<10.00 (6);

6.10<f1/Yimg<10.00 (6-1); and

6.40<f1/Yimg<7.50 (6-2), where

f1: a focal length of the first lens group, and

Yimg: a maximum image height.

Specifically, in the zoom lens according to the embodiment of the present invention, it is desirable to use glass, as a material arranged closest to the object side. Alternatively, transparent ceramic may be used.

When the zoom lens according to the embodiment of the present invention is used in tough conditions, it is desirable that a multi-layer coating for protection is applied to the zoom lens. Further, an anti-reflection coating for reducing ghost light during use or the like may be applied to the zoom lens in addition to the coating for protection.

FIG. 1 illustrates an example in which optical members PP1 through PP3 are arranged between the lens system and image plane Sim. Instead of arranging various filters, such as a low-pass filter and a filter that cuts a specific wavelength band, and the like between the lens system and image plane Sim, the various filters may be arranged between lenses. Alternatively, a coating having a similar action to the various filters may be applied to a lens surface of one of the lenses.

Next, numerical value examples of the zoom lens of the present invention will be described.

First, the zoom lens in Example 1 will be described. FIG. 1 is a cross section illustrating the lens configuration of the zoom lens in Example 1. In FIG. 1 and FIGS. 3 through 7 corresponding to Examples 2 through 6, which will be described later, the left side is an object side, and the right side is an image side. Illustrated aperture stop St does not necessarily represent the size nor the shape of the stop, but the position of the stop on optical axis Z.

Table 1 shows basic lens data of the zoom lens in Example 1. Table 2 shows data about the specification of the zoom lens in Example 1. Table 3 shows data about moving surface distances. Table 4 shows data about aspheric coefficients. In the following descriptions, the meanings of signs in the tables will be described by using the tables of Example 1, as an example. The meanings of signs in the tables of Examples 2 through 6 are basically similar to those of Example 1.

In the lens data of Table 1, a column of surface numbers shows surface numbers when a surface of composition elements closest to the object side is the first surface and the surface numbers sequentially increase toward the image side. A column of curvature radii shows the curvature radius of each surface. A column of surface distances shows a distance, on optical axis Z, between each surface and its next surface. Further, a column of nd shows the refractive index of each optical element for d-line (wavelength is 587.6 nm). A column of vd shows the Abbe number of each optical element for d-line (wavelength is 587.6 nm). Further, a column of θgf shows a partial dispersion ratio of each optical element.

Here, partial dispersion ratio θgf is represented by the following equation:

θgf=(Ng−NF)/(NF−NC), where

Ng: a refractive index for g-line,

NF: a refractive index for F-line, and

NC: a refractive index for C-line.

Here, the sign of a curvature radius is positive when a surface shape is convex toward the object side, and negative when a surface shape is convex toward the image side. The basic lens data show data including aperture stop St and optical members PP1 through PP3. In the column of surface numbers, the term “(STOP)” is written together with the surface number of a surface corresponding to aperture stop St. Further, in the lens data of Table 1, “DD[i]” is written in a row of a surface distance that changes during magnification change. Numerical values corresponding to this DD[i] are shown in Table 3.

Data about specification in Table 2 show values of zoom ratios, focal length f, back focus Bf, F-number Fno, maximum image heights and full angle of view 2ω.

In the basic lens data, data about specification and data about moving surface distances, degree is used as the unit of an angle, and mm is used as the unit of a length. Since an optical system is usable by proportionally enlarging the optical system or by proportionally reducing the optical system, other appropriate units may be used.

In the lens data of Table 1, mark “*” is attached to the surface numbers of aspherical surfaces. Further, a numerical value of a paraxial curvature radius is used as the curvature radius of an aspherical surface. The data about aspheric coefficients in Table 4 show the surface numbers of aspherical surfaces and aspheric coefficients about the aspherical surfaces. The aspheric coefficients are values of coefficients KA, Am (m=3 . . . 20) in an aspheric equation represented by the following equation:

Zd=C·h²/{1+(1−KA·C²·h²)^{1/2}}+ΣAm·hu m, where

Zd: the depth of an aspherical surface (the length of a perpendicular from a point on the aspherical surface at height h to a flat plane that contacts with the vertex of the aspherical surface and is perpendicular to the optical axis),

h: height (a length from the optical axis),

C: a reciprocal of a paraxial curvature radius, and

KA, Am: aspheric coefficients (m=3 . . . 20).

TABLE 1
EXAMPLE 1•LENS DATA

| SURFACE | CURVATURE | SURFACE | | | |
|---|---|---|---|---|---|
| NUMBER | RADIUS | DISTANCE | nd | νd | θg, f |
| 1 | 87.1412 | 2.300 | 1.77250 | 49.60 | 0.55212 |
| 2 | 38.4172 | 18.877 | | | |
| 3 | 1136.2653 | 1.850 | 1.72916 | 54.68 | 0.54451 |
| 4 | 190.5757 | 9.629 | | | |
| 5 | −76.1365 | 1.800 | 1.78590 | 44.20 | 0.56317 |
| 6 | −658.9483 | 0.400 | | | |
| *7 | 99.5770 | 4.702 | 1.73800 | 32.26 | 0.58995 |
| 8 | 211.0052 | 1.000 | | | |
| 9 | 150.6115 | 9.926 | 1.43387 | 95.20 | 0.53733 |
| 10 | −109.1464 | 6.611 | | | |
| 11 | 129.0676 | 1.900 | 1.73800 | 32.26 | 0.58995 |
| 12 | 49.4384 | 9.896 | 1.43875 | 94.93 | 0.53433 |
| 13 | 281.9814 | 0.150 | | | |
| 14 | 75.9987 | 12.197 | 1.43387 | 95.20 | 0.53733 |
| 15 | −104.0862 | 0.120 | | | |
| *16 | 50.3797 | 9.174 | 1.72916 | 54.68 | 0.54451 |
| 17 | 633.8680 | DD[17] | | | |
| *18 | 56.4068 | 1.050 | 1.90270 | 31.00 | 0.59434 |
| *19 | 16.3394 | DD[19] | | | |
| 20 | −108.0380 | 0.800 | 1.91082 | 35.25 | 0.58224 |
| 21 | 27.6404 | 1.968 | | | |
| 22 | −266.8243 | 5.441 | 1.59270 | 35.31 | 0.59336 |
| 23 | −12.5339 | 0.800 | 1.88300 | 40.76 | 0.56679 |
| 24 | −47.0473 | 0.120 | | | |
| 25 | 64.8712 | 3.121 | 1.80809 | 22.76 | 0.63073 |
| 26 | −38.0095 | 0.810 | 1.80400 | 46.58 | 0.55730 |
| 27 | −65.8582 | DD[27] | | | |
| 28 | −24.3944 | 0.810 | 1.90043 | 37.37 | 0.57720 |
| 29 | 71.3566 | 2.374 | 1.95906 | 17.47 | 0.65993 |
| 30 | −100.8274 | DD[30] | | | |
| 31(STOP) | ∞ | 1.500 | | | |
| 32 | 342.9585 | 3.180 | 1.80100 | 34.97 | 0.58642 |
| 33 | −58.5310 | 0.120 | | | |
| 34 | 98.9773 | 5.803 | 1.51633 | 64.14 | 0.53531 |
| 35 | −34.3951 | 1.146 | 1.90043 | 37.37 | 0.57720 |
| 36 | −90.7098 | 41.070 | | | |
| 37 | 68.6268 | 5.085 | 1.51633 | 64.14 | 0.53531 |
| 38 | −52.4360 | 0.120 | | | |
| 39 | 51.9592 | 5.542 | 1.58913 | 61.14 | 0.54067 |
| 40 | −51.9592 | 1.000 | 1.88100 | 40.14 | 0.57010 |
| 41 | 28.1353 | 1.034 | | | |
| 42 | 28.2428 | 7.803 | 1.59282 | 68.63 | 0.54414 |
| 43 | −28.2851 | 1.000 | 1.88100 | 40.14 | 0.57010 |
| 44 | −1811.0411 | 0.120 | | | |
| 45 | 49.7523 | 3.774 | 1.51633 | 64.14 | 0.53531 |
| 46 | −88.4604 | 0.120 | | | |
| 47 | ∞ | 1.000 | 1.51633 | 64.14 | 0.53531 |
| 48 | ∞ | 0.000 | | | |
| 49 | ∞ | 33.000 | 1.60859 | 46.44 | 0.56664 |
| 50 | ∞ | 13.200 | 1.51633 | 64.10 | 0.53463 |
| 51 | ∞ | 10.430 | | | |

TABLE 2
EXAMPLE 1•SPECIFICATION (d-LINE)

| | WIDE | | |
|---|---|---|---|
| | ANGLE | MIDDLE | TELEPHOTO |
| ZOOM RATIO | 1.00 | 9.83 | 17.30 |
| f | 5.71 | 56.11 | 98.76 |
| Bf | 39.65 | 39.65 | 39.65 |
| FNo. | 1.88 | 1.88 | 3.03 |
| MAXIMUM IMAGE HEIGHT | 5.50 | 5.50 | 5.50 |
| 2ω[°] | 91.8 | 11.2 | 6.4 |

TABLE 3
EXAMPLE 1•ZOOM DISTANCE

| | WIDE | | |
|---|---|---|---|
| | ANGLE | MIDDLE | TELEPHOTO |
| DD[17] | 0.700 | 40.495 | 43.400 |
| DD[19] | 6.651 | 6.986 | 5.990 |
| DD[27] | 36.141 | 2.343 | 10.201 |
| DD[30] | 17.267 | 10.935 | 1.167 |

TABLE 4
EXAMPLE 1•ASPHERIC COEFFICIENTS

| SURFACE NUMBER | 7 | 16 | 18 |
|---|---|---|---|
| KA | 1.0000000E+00 | 1.0000000E+00 | 1.0000000E+00 |
| A4 | 8.2485486E−07 | −1.0710746E−06 | −1.0568689E−05 |
| A6 | −7.5005484E−10 | −1.9456961E−10 | 1.7695497E−07 |
| A8 | 1.6184558E−13 | −7.7938920E−14 | 2.0878842E−09 |
| A10 | 4.3925437E−16 | −9.0278493E−17 | −2.6769163E−11 |
| A12 | −3.0518221E−19 | 1.8725510E−19 | −9.9619398E−16 |
| A14 | −3.1647629E−22 | −2.3422270E−22 | 7.7573258E−16 |
| A16 | 1.5793986E−25 | −3.3101124E−29 | 3.1970436E−19 |
| A18 | 3.4705749E−28 | 1.9527284E−28 | −2.3839186E−20 |
| A20 | −2.1508094E−31 | −1.0108403E−31 | 6.0025878E−23 |

| SURFACE NUMBER | 19 |
|---|---|
| KA | 1.0000000E+00 |
| A4 | −2.3112178E−05 |
| A6 | 1.5538703E−07 |
| A8 | 4.0136204E−09 |
| A10 | −3.1640026E−11 |
| A12 | 2.2790423E−13 |
| A14 | −5.8931167E−15 |
| A16 | 3.8708921E−17 |
| A18 | 8.2612670E−20 |
| A20 | −9.1886588E−22 |

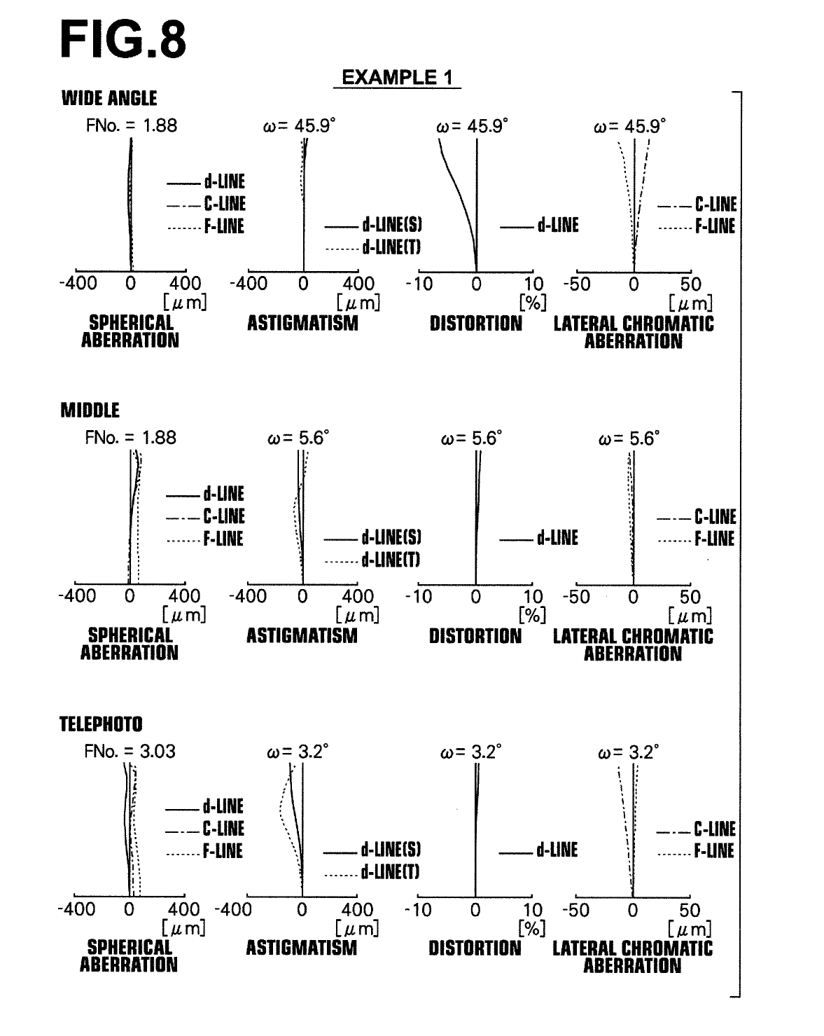

FIG. 8 is aberration diagrams of the zoom lens in Example 1. The top row of FIG. 8 shows a spherical aberration, astigmatism, distortion and a lateral chromatic aberration at a wide angle end in this order from the left side. The middle row of FIG. 8 shows a spherical aberration, astigmatism, distortion and a lateral chromatic aberration at a middle position in this order from the left side. The bottom row of FIG. 8 shows a spherical aberration, astigmatism, distortion and a lateral chromatic aberration at a telephoto end in this order from the left side. Aberration diagrams of a spherical aberration, astigmatism and distortion show aberrations when d-line (wavelength is 587.6 nm) is a reference wavelength. In the aberration diagram of the spherical aberration, aberrations for d-line (wavelength is 587.6 nm), C-line (wavelength is 656.3 nm) and F-line (wavelength is 486.1 nm) are indicated by a solid line, a dot dashed line and a dotted line, respectively. In the aberration diagram of the astigmatism, an aberration in a sagittal direction and an aberration in a tangential direction are indicated by a solid line and a dotted line, respectively. In the aberration diagram of the lateral chromatic aberration, an aberration for C-line (wavelength is 656.3 nm) and an aberration for F-line (wavelength is 486.1 nm) are indicated by a dot dashed line and a dotted line, respectively. In the aberration diagram of the spherical aberration, Fno. represents an F-number. In the other aberration diagrams, ω means a half angle of view.

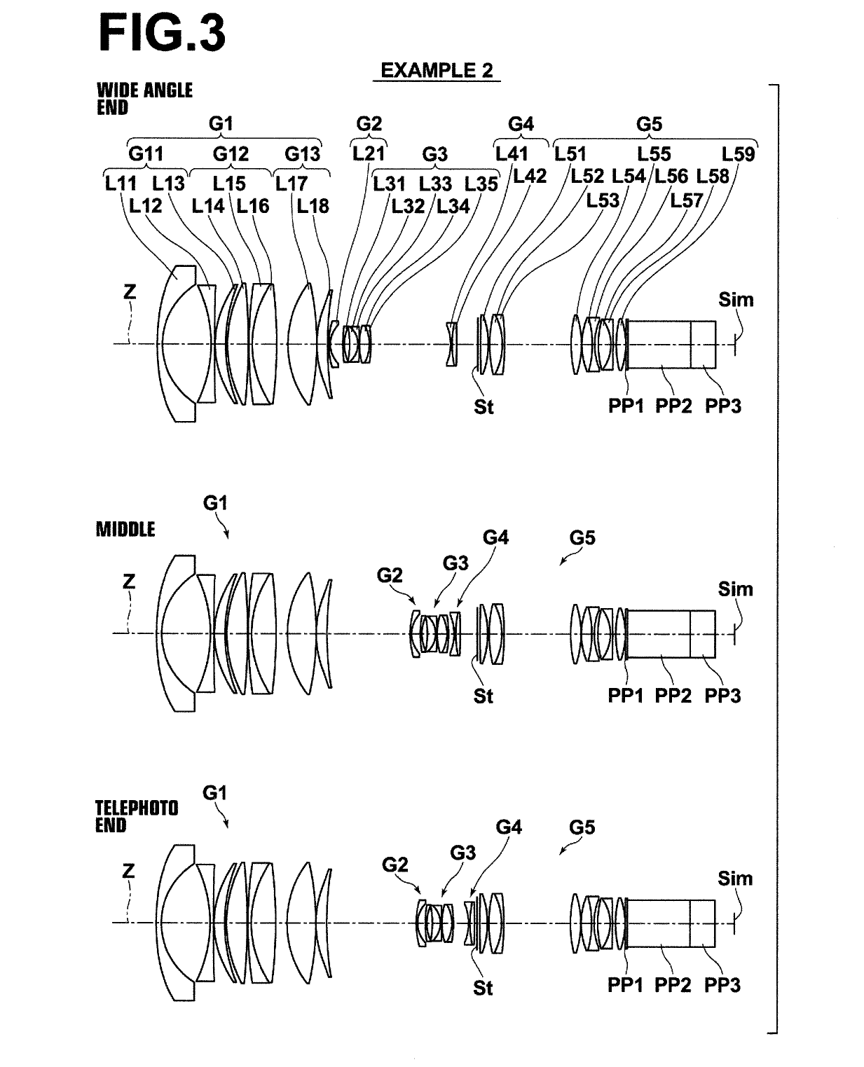

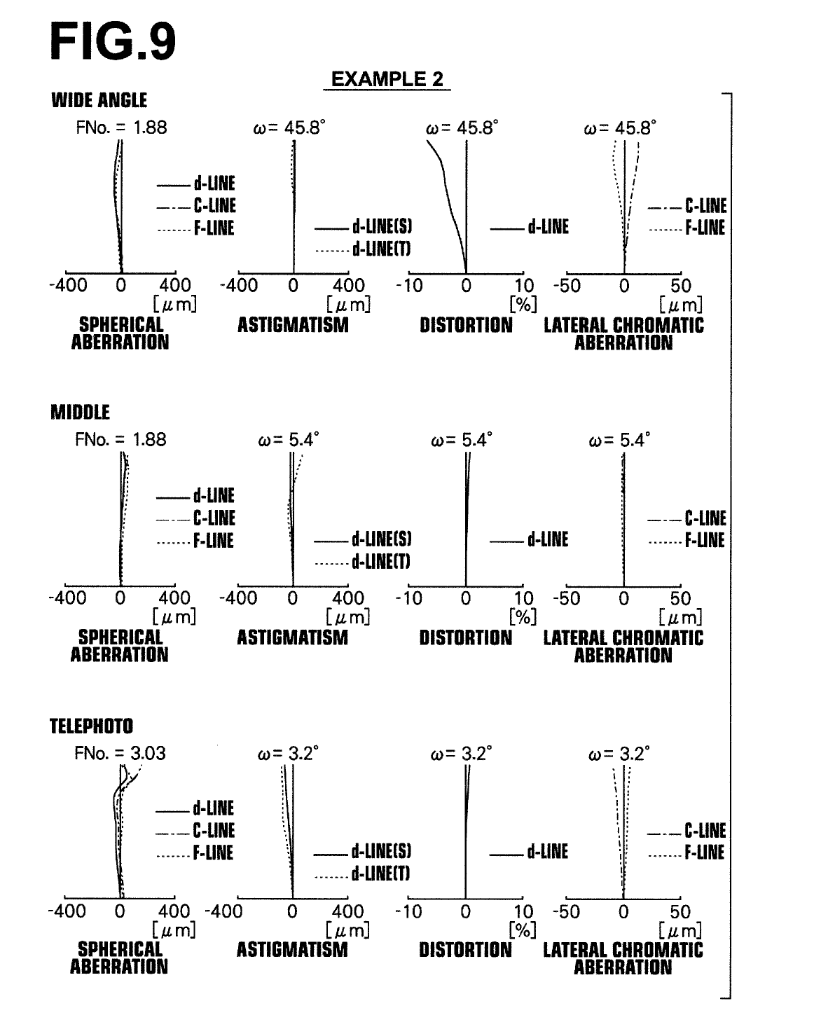

Next, a zoom lens in Example 2 will be described. FIG. 3 is a cross section illustrating the lens configuration of the zoom lens in Example 2. Further, Table 5 shows basic lens data of the zoom lens in Example 2. Table 6 shows data about the specification of the zoom lens in Example 2. Table 7 shows data about moving surface distances. Table 8 shows data about aspheric coefficients. FIG. 9 illustrates aberration diagrams.

TABLE 5
EXAMPLE 2•LENS DATA

| SURFACE | CURVATURE | SURFACE | | | |
|---|---|---|---|---|---|
| NUMBER | RADIUS | DISTANCE | nd | νd | θg, f |
| *1 | 124.7850 | 2.689 | 1.77250 | 49.60 | 0.55212 |
| 2 | 37.7474 | 25.827 | | | |
| 3 | −72.1808 | 1.800 | 1.77250 | 49.60 | 0.55212 |
| 4 | 892.5323 | 0.400 | | | |
| *5 | 49.5174 | 5.628 | 1.59270 | 35.31 | 0.59336 |
| 6 | 86.0952 | 1.000 | | | |
| 7 | 70.2268 | 10.906 | 1.43387 | 95.20 | 0.53733 |
| 8 | −339.6204 | 0.270 | | | |
| 9 | 222.2437 | 1.800 | 1.73800 | 32.26 | 0.58995 |
| 10 | 58.9750 | 12.800 | 1.43875 | 94.93 | 0.53433 |
| 11 | −266.6534 | 5.945 | | | |
| 12 | 54.7734 | 15.315 | 1.43387 | 95.20 | 0.53733 |
| 13 | −150.6750 | 0.120 | | | |
| *14 | 51.5799 | 5.752 | 1.72916 | 54.68 | 0.54451 |
| 15 | 180.4270 | DD[15] | | | |
| 16 | 45.1458 | 0.800 | 2.00100 | 29.13 | 0.59952 |
| 17 | 15.4128 | DD[17] | | | |
| 18 | 62.7221 | 0.800 | 1.95375 | 32.32 | 0.59015 |
| 19 | 22.0548 | 2.895 | | | |
| 20 | −47.8200 | 4.273 | 1.80518 | 25.42 | 0.61616 |
| 21 | −12.9068 | 0.800 | 1.88300 | 40.76 | 0.56679 |
| 22 | −184.3777 | 0.120 | | | |
| 23 | 36.4785 | 5.259 | 1.69895 | 30.13 | 0.60298 |
| 24 | −20.0339 | 0.800 | 1.88300 | 40.76 | 0.56679 |
| 25 | −65.2637 | DD[25] | | | |
| 26 | −26.3654 | 0.810 | 1.83400 | 37.16 | 0.57759 |
| 27 | 55.5101 | 2.419 | 1.95906 | 17.47 | 0.65993 |
| 28 | −230.0909 | DD[28] | | | |
| 29(STOP) | ∞ | 1.500 | | | |
| 30 | 643.4052 | 4.054 | 1.95375 | 32.32 | 0.59015 |
| 31 | −47.6654 | 0.695 | | | |
| 32 | 70.8397 | 6.756 | 1.51633 | 64.14 | 0.53531 |
| 33 | −35.4423 | 1.200 | 2.00100 | 29.13 | 0.59952 |
| 34 | −127.2020 | 35.154 | | | |
| 35 | 69.1338 | 5.518 | 1.51633 | 64.14 | 0.53531 |
| 36 | −49.7008 | 0.190 | | | |
| 37 | 40.0107 | 5.535 | 1.48749 | 70.23 | 0.53007 |
| 38 | −54.6714 | 1.200 | 1.81600 | 46.62 | 0.55682 |
| 39 | 33.2300 | 2.090 | | | |
| 40 | 54.1336 | 6.601 | 1.59282 | 68.63 | 0.54414 |
| 41 | −22.6308 | 1.200 | 1.91082 | 35.25 | 0.58224 |
| 42 | −820.0108 | 1.620 | | | |
| 43 | 59.4867 | 5.126 | 1.51633 | 64.14 | 0.53531 |
| 44 | −41.8596 | 0.120 | | | |
| 45 | ∞ | 1.000 | 1.51633 | 64.14 | 0.53531 |
| 46 | ∞ | 0.000 | | | |
| 47 | ∞ | 33.000 | 1.60859 | 46.44 | 0.56664 |
| 48 | ∞ | 13.200 | 1.51633 | 64.10 | 0.53463 |
| 49 | ∞ | 10.348 | | | |

TABLE 6
EXAMPLE 2•SPECIFICATION (d-LINE)

| | WIDE | | |
|---|---|---|---|
| | ANGLE | MIDDLE | TELEPHOTO |
| ZOOM RATIO | 1.00 | 10.01 | 17.30 |
| f | 5.73 | 57.35 | 99.12 |
| Bf | 39.57 | 39.57 | 39.57 |
| FNo. | 1.88 | 1.88 | 3.03 |
| MAXIMUM IMAGE HEIGHT | 5.50 | 5.50 | 5.50 |
| 2ω[°] | 91.6 | 10.8 | 6.4 |

TABLE 7
EXAMPLE 2•ZOOM DISTANCE

| | WIDE | | |
|---|---|---|---|
| | ANGLE | MIDDLE | TELEPHOTO |
| DD[15] | 0.650 | 43.760 | 47.134 |
| DD[17] | 6.545 | 4.682 | 4.065 |
| DD[25] | 42.063 | 2.965 | 7.958 |
| DD[28] | 11.106 | 8.957 | 1.207 |

TABLE 8
EXAMPLE 2•ASPHERIC COEFFICIENTS

| SURFACE NUMBER | 1 | 5 | 14 |
|---|---|---|---|
| KA | 1.0000000E+00 | 1.0000000E+00 | 1.0000000E+00 |
| A4 | 5.2505930E−08 | −3.5687571E−09 | −1.9280825E−06 |
| A6 | 1.1616876E−09 | −2.1257577E−09 | −7.8956322E−10 |
| A8 | −6.0416610E−13 | 1.0336393E−12 | −3.3616325E−13 |
| A10 | −1.3868729E−18 | 3.5341212E−16 | −5.4950910E−17 |
| A12 | 9.9799255E−20 | −6.9602547E−19 | 1.9800037E−20 |
| A14 | 4.9006064E−24 | −1.3764973E−22 | −3.3569246E−22 |
| A16 | −1.2331637E−26 | 4.1688838E−25 | −5.4608475E−25 |
| A18 | −6.8046320E−30 | −3.3328819E−29 | 1.3606563E−27 |
| A20 | 3.1696454E−33 | −7.3557201E−32 | −6.9412805E−31 |

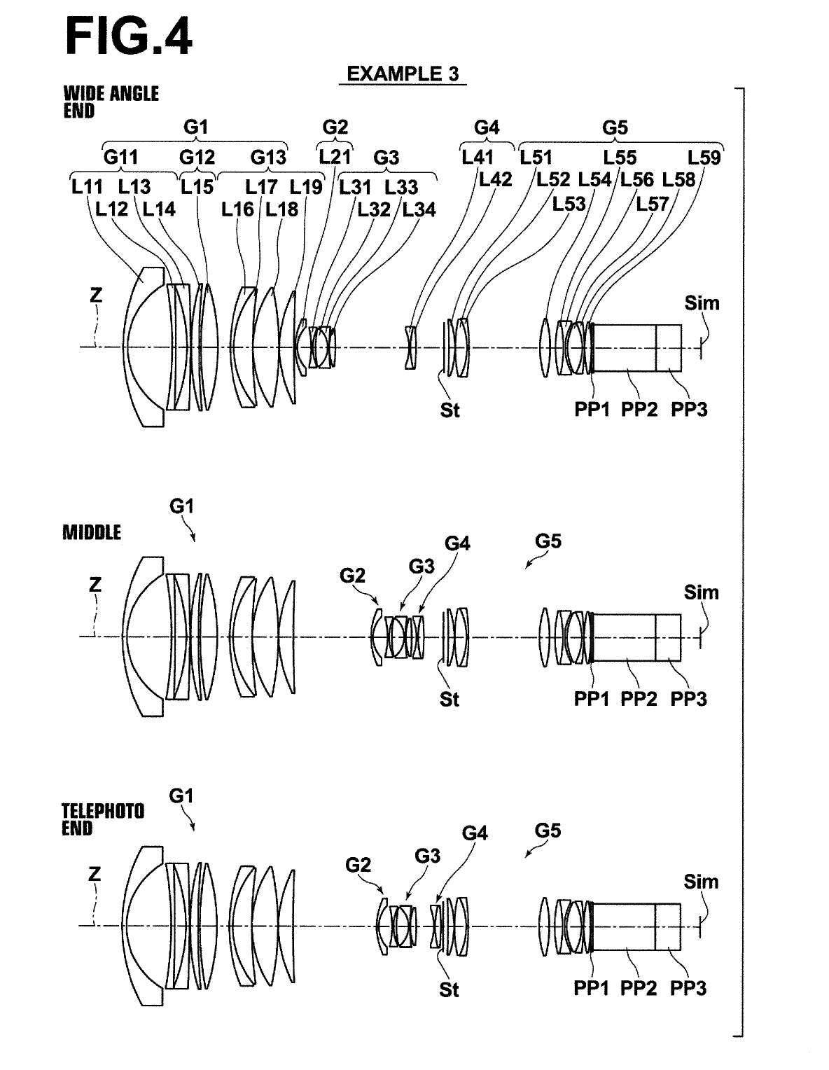

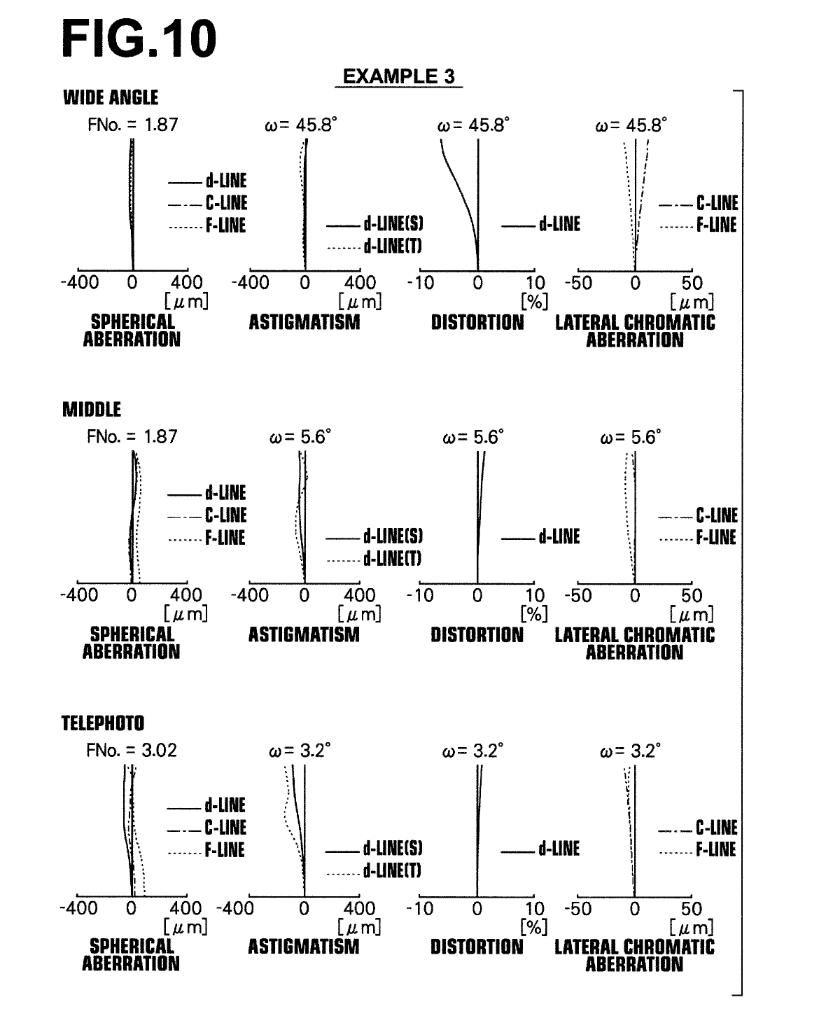

Next, a zoom lens in Example 3 will be described. FIG. 4 is a cross section illustrating the lens configuration of the zoom lens in Example 3. Further, Table 9 shows basic lens data of the zoom lens in Example 3. Table 10 shows data about the specification of the zoom lens in Example 3. Table 11 shows data about moving surface distances. Table 12 shows data about aspheric coefficients. FIG. 10 illustrates aberration diagrams.

TABLE 9
EXAMPLE 3•LENS DATA

| SURFACE | CURVATURE | SURFACE | | | |
|---|---|---|---|---|---|
| NUMBER | RADIUS | DISTANCE | nd | νd | θg, f |
| 1 | 90.6131 | 2.300 | 1.78800 | 47.37 | 0.55598 |
| 2 | 38.9314 | 23.377 | | | |
| 3 | −193.5529 | 1.900 | 1.78800 | 47.37 | 0.55598 |
| 4 | −869.7483 | 5.936 | | | |
| 5 | −84.9562 | 1.850 | 1.79952 | 42.22 | 0.56727 |
| 6 | −723.1704 | 0.400 | | | |
| *7 | 168.5058 | 4.082 | 1.73800 | 32.26 | 0.58995 |
| 8 | 360.9892 | 1.000 | | | |
| 9 | 189.7742 | 8.990 | 1.43387 | 95.20 | 0.53733 |
| 10 | −114.6220 | 6.566 | | | |
| 11 | 85.8190 | 1.900 | 1.73800 | 32.26 | 0.58995 |
| 12 | 49.0120 | 9.986 | 1.43875 | 94.93 | 0.53433 |
| 13 | 225.8328 | 0.150 | | | |
| 14 | 58.1528 | 13.725 | 1.43387 | 95.20 | 0.53733 |
| 15 | −152.7245 | 0.120 | | | |
| *16 | 56.3471 | 7.679 | 1.72916 | 54.68 | 0.54451 |
| 17 | 669.6852 | DD[17] | | | |
| *18 | 35.0205 | 1.050 | 2.00069 | 25.46 | 0.61364 |
| 19 | 15.8296 | DD[19] | | | |
| 20 | −47.7233 | 0.800 | 1.95375 | 32.32 | 0.59015 |
| 21 | 24.6937 | 1.426 | | | |
| 22 | 50.5441 | 6.397 | 1.75211 | 25.05 | 0.61924 |
| 23 | −13.5280 | 0.800 | 1.75500 | 52.32 | 0.54765 |
| 24 | 94.4253 | 0.100 | | | |
| 25 | 30.4183 | 3.126 | 1.54814 | 45.79 | 0.56859 |
| 26 | −96.3857 | DD[26] | | | |
| 27 | −26.8812 | 0.810 | 1.95375 | 32.32 | 0.59015 |
| 28 | 43.2070 | 2.937 | 1.95906 | 17.47 | 0.65993 |
| 29 | −106.0261 | DD[29] | | | |
| 30(STOP) | ∞ | 2.574 | | | |
| 31 | −333.6516 | 3.175 | 1.83400 | 37.16 | 0.57759 |
| 32 | −46.0935 | 0.152 | | | |
| 33 | 71.9795 | 6.312 | 1.51633 | 64.14 | 0.53531 |
| 34 | −35.7240 | 1.100 | 1.90043 | 37.37 | 0.57720 |
| 35 | −105.3597 | 37.469 | | | |
| 36 | 53.0120 | 5.295 | 1.51633 | 64.14 | 0.53531 |
| 37 | −64.9483 | 2.752 | | | |
| 38 | 63.5100 | 4.205 | 1.51823 | 58.90 | 0.54567 |
| 39 | −63.5100 | 1.000 | 1.83400 | 37.16 | 0.57759 |
| 40 | 27.3328 | 1.258 | | | |
| 41 | 28.9150 | 7.682 | 1.53775 | 74.70 | 0.53936 |
| 42 | −28.9150 | 1.000 | 1.88300 | 40.76 | 0.56679 |
| 43 | −105.8139 | 0.146 | | | |
| 44 | 59.9049 | 3.695 | 1.48749 | 70.23 | 0.53007 |
| 45 | −81.3464 | 0.110 | | | |
| 46 | ∞ | 1.000 | 1.51633 | 64.14 | 0.53531 |
| 47 | ∞ | 0.000 | | | |
| 48 | ∞ | 33.000 | 1.60859 | 46.44 | 0.56664 |
| 49 | ∞ | 13.200 | 1.51633 | 64.10 | 0.53463 |
| 50 | ∞ | 10.438 | | | |

TABLE 10
EXAMPLE 3•SPECIFICATION (d-LINE)

| | WIDE | | |
|---|---|---|---|
| | ANGLE | MIDDLE | TELEPHOTO |
| ZOOM RATIO | 1.00 | 9.78 | 17.30 |
| f | 5.71 | 55.84 | 98.78 |
| Bf | 39.66 | 39.66 | 39.66 |
| FNo. | 1.87 | 1.87 | 3.02 |
| MAXIMUM IMAGE HEIGHT | 5.50 | 5.50 | 5.50 |
| 2ω[°] | 91.6 | 11.2 | 6.4 |

TABLE 11
EXAMPLE 3•ZOOM DISTANCE

| | WIDE | | |
|---|---|---|---|
| | ANGLE | MIDDLE | TELEPHOTO |
| DD[17] | 0.700 | 41.013 | 44.163 |
| DD[19] | 7.422 | 7.722 | 7.122 |
| DD[26] | 38.824 | 2.501 | 9.157 |
| DD[29] | 14.604 | 10.314 | 1.107 |

TABLE 12
EXAMPLE 3•ASPHERIC COEFFICIENTS

| SURFACE NUMBER | 7 | 16 | 18 |
|---|---|---|---|
| KA | 1.0000000E+00 | 1.0000000E+00 | 1.0000000E+00 |
| A3 | 0.0000000E+00 | 0.0000000E+00 | 0.0000000E+00 |
| A4 | 1.5662594E−06 | −1.6339247E−06 | 5.3341913E−06 |
| A5 | −1.5980406E−08 | 4.8479758E−09 | −3.1631414E−07 |
| A6 | −7.6009432E−10 | −1.5505418E−10 | −9.0986429E−08 |
| A7 | 9.4348728E−12 | −7.7388270E−13 | 4.8517680E−09 |
| A8 | 4.2992946E−13 | −3.2111185E−13 | 1.5150584E−09 |
| A9 | 1.5540379E−15 | 7.2008164E−17 | −3.0159963E−11 |
| A10 | 1.6073629E−16 | −4.4449392E−17 | −7.0948157E−12 |
| A11 | −9.8522343E−18 | 3.5580264E−18 | −1.5064780E−12 |
| A12 | −4.8985147E−19 | 2.8443570E−19 | 1.3498702E−13 |
| A13 | 1.6770262E−21 | −1.1494670E−21 | 6.3798049E−16 |
| A14 | 1.2217368E−22 | −3.1899520E−22 | 2.5872931E−16 |
| A15 | 7.8247184E−24 | −2.5462429E−24 | 5.2731514E−18 |
| A16 | 2.4957504E−25 | −5.6586671E−26 | −2.8468654E−18 |
| A17 | −3.7808612E−27 | −7.8711827E−28 | −3.1635259E−19 |
| A18 | −1.0408156E−28 | 3.4903376E−28 | 2.4905198E−20 |
| A19 | −5.1896646E−30 | 5.6003320E−30 | 8.2480238E−22 |
| A20 | 1.1243730E−31 | −2.8770392E−31 | −5.8179388E−23 |

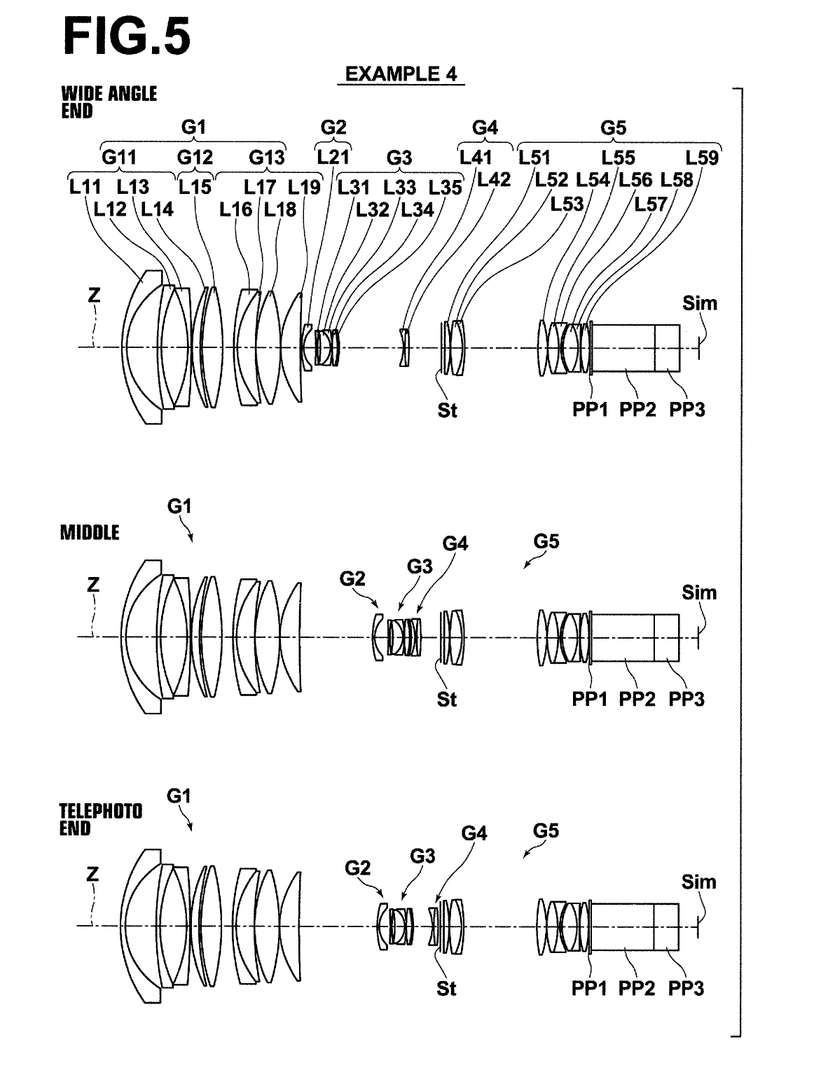

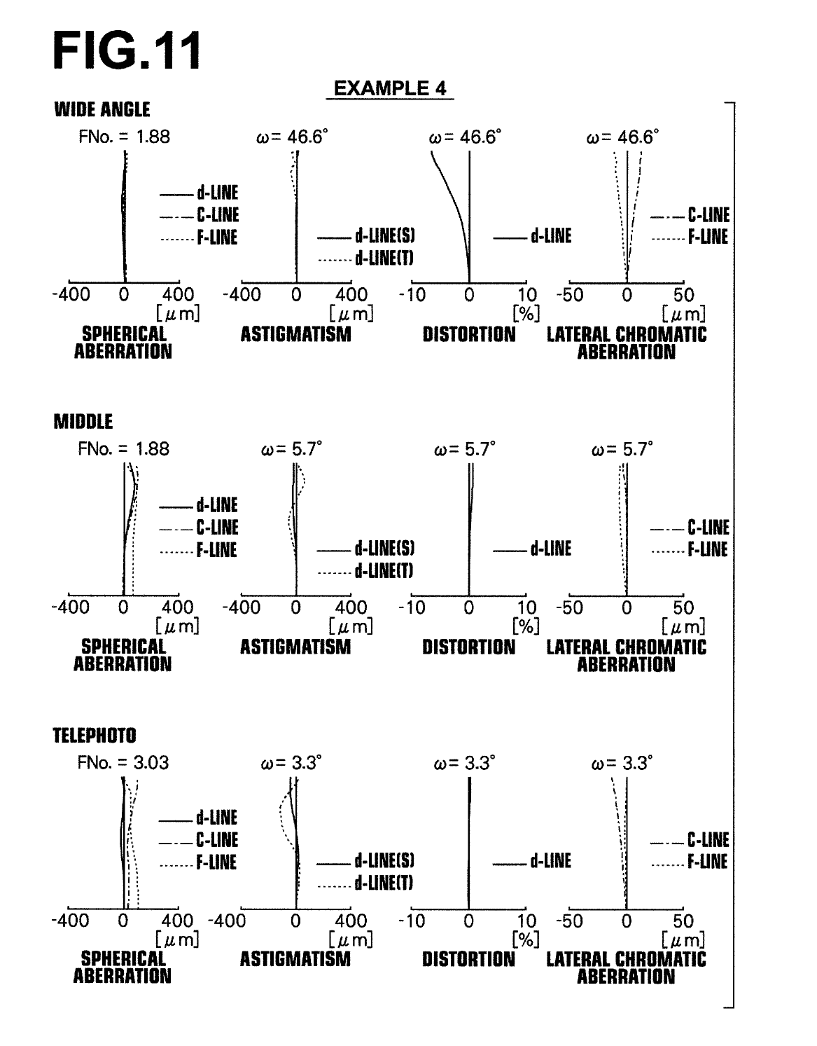

Next, a zoom lens in Example 4 will be described. FIG. 5 is a cross section illustrating the lens configuration of the zoom lens in Example 4. Further, Table 13 shows basic lens data of the zoom lens in Example 4. Table 14 shows data about the specification of the zoom lens in Example 4. Table 15 shows data about moving surface distances. Table 16 shows data about aspheric coefficients. FIG. 11 illustrates aberration diagrams.

TABLE 13
EXAMPLE 4•LENS DATA

| SURFACE | CURVATURE | SURFACE | | | |
|---|---|---|---|---|---|
| NUMBER | RADIUS | DISTANCE | nd | νd | θg, f |
| 1 | 71.8629 | 2.530 | 1.77250 | 49.60 | 0.55212 |
| 2 | 39.3487 | 16.343 | | | |
| 3 | 168.6690 | 2.080 | 1.80000 | 48.00 | 0.55236 |
| 4 | 74.3922 | 14.126 | | | |
| 5 | −70.7539 | 1.800 | 1.80601 | 40.17 | 0.57258 |
| 6 | −402.4203 | 0.400 | | | |
| *7 | 79.5376 | 4.267 | 1.73800 | 32.26 | 0.58995 |
| 8 | 127.4804 | 1.000 | | | |
| 9 | 103.7214 | 10.668 | 1.43387 | 95.20 | 0.53733 |
| 10 | −136.1925 | 5.894 | | | |
| 11 | 116.1904 | 1.900 | 1.73800 | 32.26 | 0.58995 |
| 12 | 46.7634 | 9.595 | 1.43875 | 94.93 | 0.53433 |
| 13 | 158.2057 | 0.150 | | | |
| 14 | 69.3076 | 12.940 | 1.43387 | 95.20 | 0.53733 |
| 15 | −108.4350 | 0.120 | | | |
| *16 | 43.3072 | 10.466 | 1.69350 | 53.21 | 0.54731 |
| 17 | 647.5775 | DD[17] | | | |
| *18 | 52.1282 | 1.050 | 1.95375 | 32.32 | 0.59015 |
| 19 | 13.9906 | DD[19] | | | |
| 20 | −129.7676 | 0.800 | 1.88300 | 40.76 | 0.56679 |
| 21 | 60.3695 | 1.503 | | | |
| 22 | −53.0783 | 5.262 | 1.59270 | 35.31 | 0.59336 |
| 23 | −11.6434 | 0.800 | 1.88300 | 40.76 | 0.56679 |
| 24 | −49.9927 | 0.120 | | | |
| 25 | 92.9700 | 2.833 | 1.80809 | 22.76 | 0.63073 |
| 25 | −37.3623 | 0.810 | 1.80440 | 39.59 | 0.57297 |
| 27 | −46.5171 | DD[27] | | | |
| 28 | −22.8236 | 0.810 | 1.88300 | 40.80 | 0.56557 |
| 29 | 76.7937 | 2.224 | 1.95906 | 17.47 | 0.65993 |
| 30 | −99.2904 | DD[30] | | | |
| 31 (STOP) | ∞ | 1.785 | | | |
| 32 | −2456.9957 | 2.911 | 1.83400 | 37.16 | 0.57759 |
| 33 | −61.7252 | 0.120 | | | |
| 34 | 76.6777 | 6.324 | 1.51742 | 52.43 | 0.55649 |
| 35 | −33.9570 | 1.200 | 1.90043 | 37.37 | 0.57720 |
| 36 | −77.2520 | 38.464 | | | |
| 37 | 83.9810 | 5.121 | 1.51633 | 64.14 | 0.53531 |
| 38 | −48.4288 | 0.120 | | | |
| 39 | 43.8681 | 5.771 | 1.58913 | 61.14 | 0.54067 |
| 40 | −43.8681 | 1.200 | 1.88100 | 40.14 | 0.57010 |
| 41 | 25.8903 | 1.073 | | | |
| 42 | 26.4757 | 7.998 | 1.60300 | 65.44 | 0.54022 |
| 43 | −26.9705 | 1.200 | 1.88300 | 40.76 | 0.56679 |
| 44 | 249.9254 | 0.120 | | | |
| 45 | 48.2449 | 4.878 | 1.51633 | 64.14 | 0.53531 |
| 46 | −52.6169 | 0.120 | | | |
| 47 | ∞ | 1.000 | 1.51633 | 64.14 | 0.53531 |
| 48 | ∞ | 0.000 | | | |
| 49 | ∞ | 33.000 | 1.60859 | 46.44 | 0.56664 |
| 50 | ∞ | 13.200 | 1.51633 | 64.10 | 0.53463 |
| 51 | ∞ | 10.295 | | | |

TABLE 14
EXAMPLE 4•SPECIFICATION (d-LINE)

| | WIDE | | |
|---|---|---|---|
| | ANGLE | MIDDLE | TELEPHOTO |
| ZOOM RATIO | 1.00 | 9.83 | 17.30 |
| f | 5.71 | 56.13 | 98.78 |
| Bf | 39.51 | 39.51 | 39.51 |
| FNo. | 1.88 | 1.88 | 3.03 |
| MAXIMUM IMAGE HEIGHT | 5.50 | 5.50 | 5.50 |
| 2ω[°] | 93.2 | 11.4 | 6.6 |

TABLE 15
EXAMPLE 4•ZOOM DISTANCE

| | WIDE | | |
|---|---|---|---|
| | ANGLE | MIDDLE | TELEPHOTO |
| DD[17] | 0.700 | 38.371 | 41.009 |
| DD[19] | 6.545 | 7.281 | 5.937 |
| DD[27] | 33.810 | 2.024 | 10.201 |
| DD[30] | 17.265 | 10.643 | 1.173 |

TABLE 16
EXAMPLE 4•ASPHERIC COEFFICIENTS

| SURFACE NUMBER | 7 | 16 | 18 |
|---|---|---|---|
| KA | 1.0000000E+00 | 1.0000000E+00 | 1.0000000E+00 |
| A4 | 1.0854531E−06 | −1.7307783E−06 | 1.2066680E−05 |
| A6 | −1.1880191E−09 | −4.3074733E−10 | −5.6034452E−08 |
| A8 | 1.3317899E−13 | −2.8417337E−13 | 9.0273078E−10 |
| A10 | 6.9778348E−16 | 2.7649216E−17 | −5.1325344E−12 |
| A12 | −2.8394549E−19 | 9.7145539E−20 | −5.3199910E−15 |
| A14 | −4.7530860E−22 | −3.4602552E−22 | 9.1603603E−17 |
| A16 | 8.2107221E−26 | 1.7251660E−26 | 5.5946324E−19 |
| A18 | 4.9046841E−28 | 2.9995316E−28 | −5.5040742E−21 |
| A20 | −2.5362905E−31 | −1.5900668E−31 | 1.1138885E−23 |

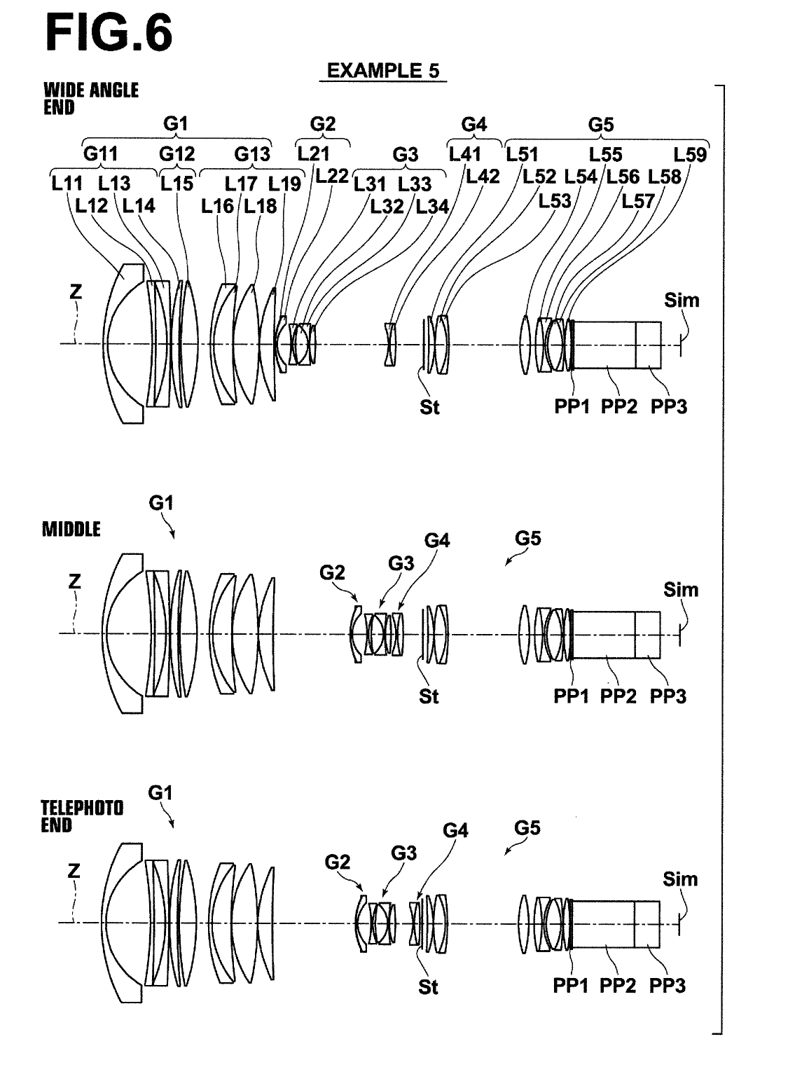

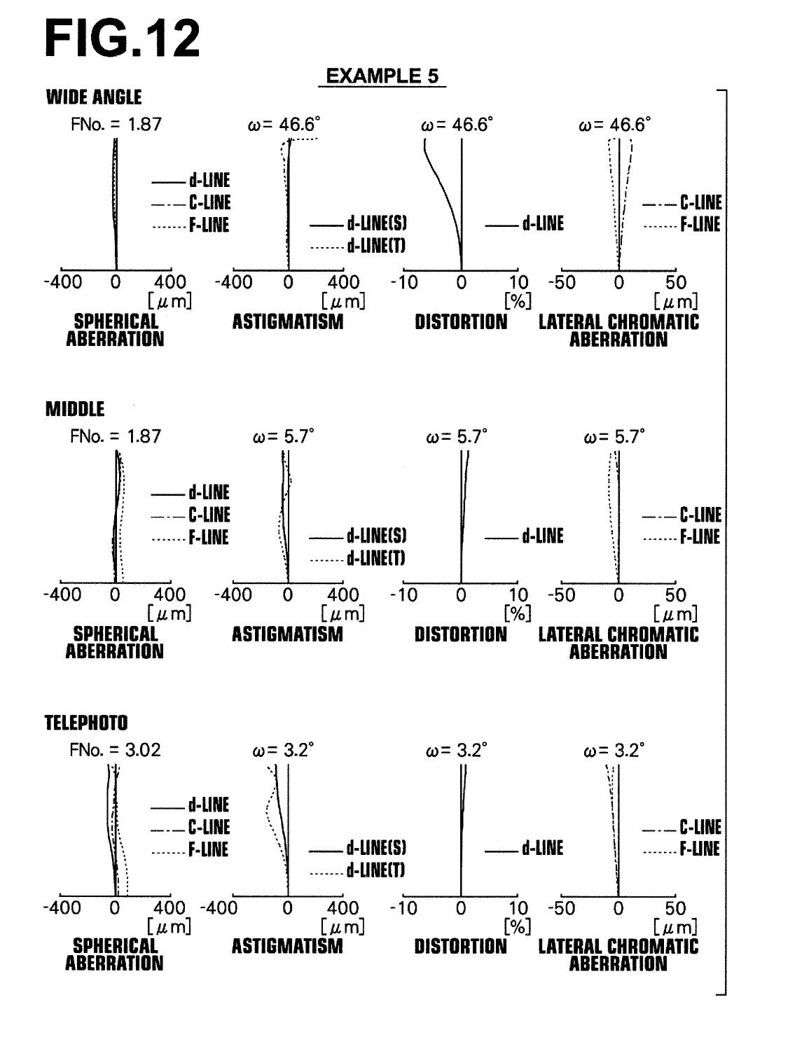

Next, a zoom lens in Example 5 will be described. FIG. 6 is a cross section illustrating the lens configuration of the zoom lens in Example 5. Further, Table 17 shows basic lens data of the zoom lens in Example 5. Table 18 shows data about the specification of the zoom lens in Example 5. Table 19 shows data about moving surface distances. Table 20 shows data about aspheric coefficients. FIG. 12 illustrates aberration diagrams.

TABLE 17
EXAMPLE 5•LENS DATA

| SURFACE | CURVATURE | SURFACE | | | |
|---|---|---|---|---|---|
| NUMBER | RADIUS | DISTANCE | nd | νd | θg, f |
| 1 | 90.6713 | 2.300 | 1.78800 | 47.37 | 0.55598 |
| 2 | 38.9114 | 23.410 | | | |
| 3 | −193.8697 | 1.900 | 1.78800 | 47.37 | 0.55598 |
| 4 | −822.7499 | 5.949 | | | |
| 5 | −84.3161 | 1.850 | 1.79952 | 42.22 | 0.56727 |
| 6 | −711.2386 | 0.389 | | | |
| *7 | 168.4069 | 4.085 | 1.73800 | 32.26 | 0.58995 |
| 8 | 362.5204 | 1.000 | | | |
| 9 | 190.1777 | 9.023 | 1.43387 | 95.20 | 0.53733 |
| 10 | −113.6956 | 6.506 | | | |
| 11 | 85.8521 | 1.900 | 1.73800 | 32.26 | 0.58995 |
| 12 | 49.0231 | 10.012 | 1.43875 | 94.93 | 0.53433 |
| 13 | 229.0757 | 0.150 | | | |
| 14 | 58.1551 | 13.705 | 1.43387 | 95.20 | 0.53733 |
| 15 | −153.3429 | 0.120 | | | |
| *16 | 56.3440 | 7.681 | 1.72916 | 54.68 | 0.54451 |
| 17 | 670.9336 | DD[17] | | | |
| *18 | 34.6343 | 0.182 | 1.51946 | 54.02 | 0.56168 |
| 19 | 34.2348 | 0.940 | 2.00069 | 25.46 | 0.61364 |
| 20 | 15.7127 | DD[20] | | | |
| 21 | −47.6439 | 0.800 | 1.95375 | 32.32 | 0.59015 |
| 22 | 24.8513 | 1.399 | | | |
| 23 | 50.4300 | 6.445 | 1.75211 | 25.05 | 0.61924 |
| 24 | −13.4835 | 0.800 | 1.75500 | 52.32 | 0.54765 |
| 25 | 93.9604 | 0.100 | | | |
| 26 | 30.3620 | 3.118 | 1.54814 | 45.79 | 0.56859 |
| 27 | −98.3536 | DD[27] | | | |
| 28 | −26.8019 | 0.810 | 1.95375 | 32.32 | 0.59015 |
| 29 | 42.9112 | 2.949 | 1.95906 | 17.47 | 0.65993 |
| 30 | −105.9353 | DD[30] | | | |
| 31(STOP) | ∞ | 2.575 | | | |
| 32 | −333.5124 | 3.163 | 1.83400 | 37.16 | 0.57759 |
| 33 | −46.2534 | 0.120 | | | |
| 34 | 71.8290 | 6.311 | 1.51633 | 64.14 | 0.53531 |
| 35 | −35.7503 | 1.100 | 1.90043 | 37.37 | 0.57720 |
| 36 | −105.0212 | 37.518 | | | |
| 37 | 52.9810 | 5.298 | 1.51633 | 64.14 | 0.53531 |
| 38 | −64.9608 | 2.747 | | | |
| 39 | 63.3716 | 4.211 | 1.51823 | 58.90 | 0.54567 |
| 40 | −63.4080 | 1.000 | 1.83400 | 37.16 | 0.57759 |
| 41 | 27.3344 | 1.286 | | | |
| 42 | 28.9215 | 7.683 | 1.53775 | 74.70 | 0.53936 |
| 43 | −28.9332 | 1.000 | 1.88300 | 40.76 | 0.56679 |
| 44 | −105.9622 | 0.120 | | | |
| 45 | 59.8040 | 3.690 | 1.48749 | 70.23 | 0.53007 |
| 46 | −81.8584 | 0.140 | | | |
| 47 | ∞ | 1.000 | 1.51633 | 64.14 | 0.53531 |
| 48 | ∞ | 0.000 | | | |
| 49 | ∞ | 33.000 | 1.60859 | 46.44 | 0.56664 |
| 50 | ∞ | 13.200 | 1.51633 | 64.10 | 0.53463 |
| 51 | ∞ | 10.433 | | | |

TABLE 18
EXAMPLE 5•SPECIFICATION (d-LINIE)

| | WIDE | | |
|---|---|---|---|
| | ANGLE | MIDDLE | TELEPHOTO |
| ZOOM RATIO | 1.00 | 9.78 | 17.30 |
| f | 5.71 | 55.84 | 98.77 |
| Bf | 39.65 | 39.65 | 39.65 |
| FNo. | 1.87 | 1.87 | 3.02 |
| MAXIMUM IMAGE HEIGHT | 5.50 | 5.50 | 5.50 |
| 2ω[°] | 93.2 | 11.4 | 6.4 |

TABLE 19
EXAMPLE 5•ZOOM DISTANCE

| | WIDE | | |
|---|---|---|---|
| | ANGLE | MIDDLE | TELEPHOTO |
| DD[17] | 0.554 | 40.757 | 43.893 |
| DD[20] | 7.464 | 7.764 | 7.164 |
| DD[27] | 38.682 | 2.522 | 9.189 |
| DD[30] | 14.704 | 10.361 | 1.158 |

TABLE 20
EXAMPLE 5•ASPHERIC COEFFICIENTS

| SURFACE NUMBER | 7 | 16 | 18 |
|---|---|---|---|
| KA | 1.0000000E+00 | 1.0000000E+00 | 1.0000000E+00 |
| A3 | −7.1232558E−08 | 2.5718376E−08 | −1.0640674E−06 |
| A4 | 1.5638755E−06 | −1.6350566E−06 | 1.1274611E−05 |
| A5 | −1.6011326E−08 | 4.8307795E−09 | −1.1273184E−06 |
| A6 | −7.6036270E−10 | −1.5522261E−10 | −9.6951926E−08 |
| A7 | 9.4337217E−12 | −7.7280077E−13 | 1.1238010E−08 |
| A8 | 4.2993658E−13 | −3.2097564E−13 | 1.7118209E−09 |
| A9 | 1.5552703E−15 | 7.6952655E−17 | −5.0209088E−11 |
| A10 | 1.6086766E−16 | −4.4324940E−17 | −9.4189862E−12 |
| A11 | −9.8440235E−18 | 3.5603154E−18 | −1.6471114E−12 |
| A12 | −4.8950868E−19 | 2.8445858E−19 | 1.4073819E−13 |
| A13 | 1.6865022E−21 | −1.1498618E−21 | 1.6531707E−15 |
| A14 | 1.2227931E−22 | −3.1902580E−22 | 2.9442331E−16 |
| A15 | 7.8188489E−24 | −2.5472971E−24 | 7.6667688E−18 |
| A16 | 2.4911528E−25 | −5.6611464E−26 | −2.8978589E−18 |
| A17 | −3.7993099E−27 | −7.8742229E−28 | −3.4902727E−19 |
| A18 | −1.0453876E−28 | 3.4904171E−28 | 2.3641763E−20 |
| A19 | −5.1887389E−30 | 5.6011033E−30 | 8.7133615E−22 |
| A20 | 1.1334080E−31 | −2.8766683E−31 | −5.2954326E−23 |

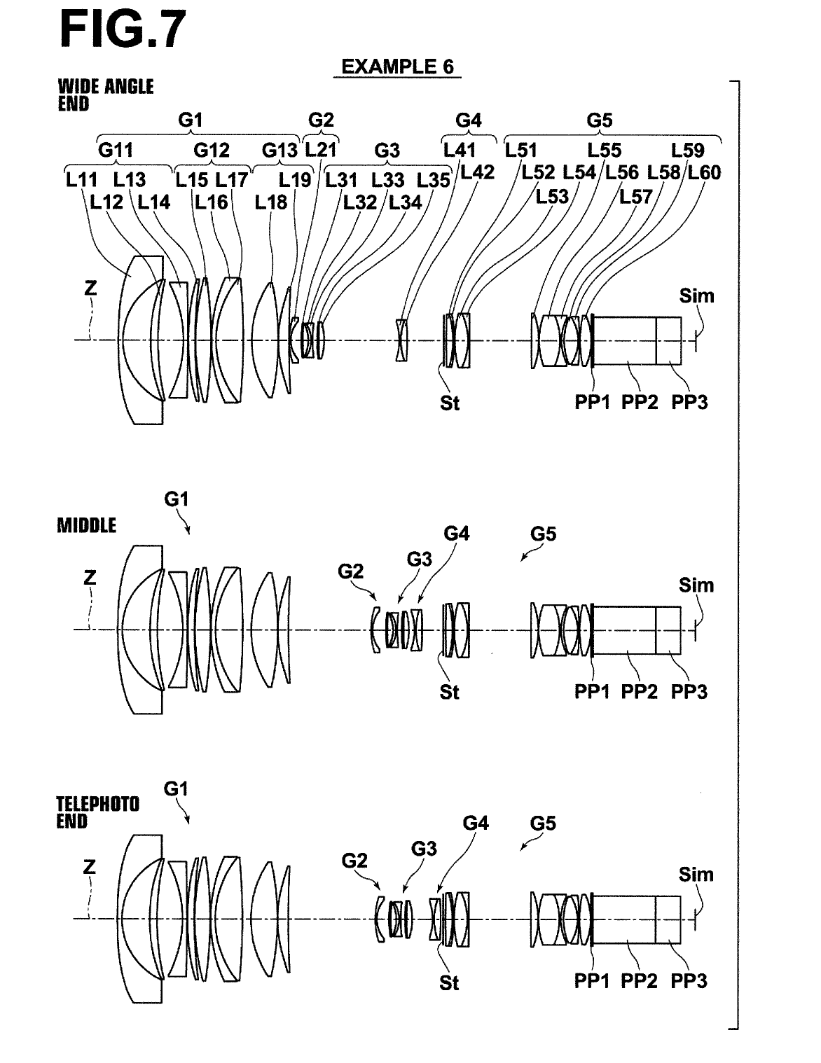

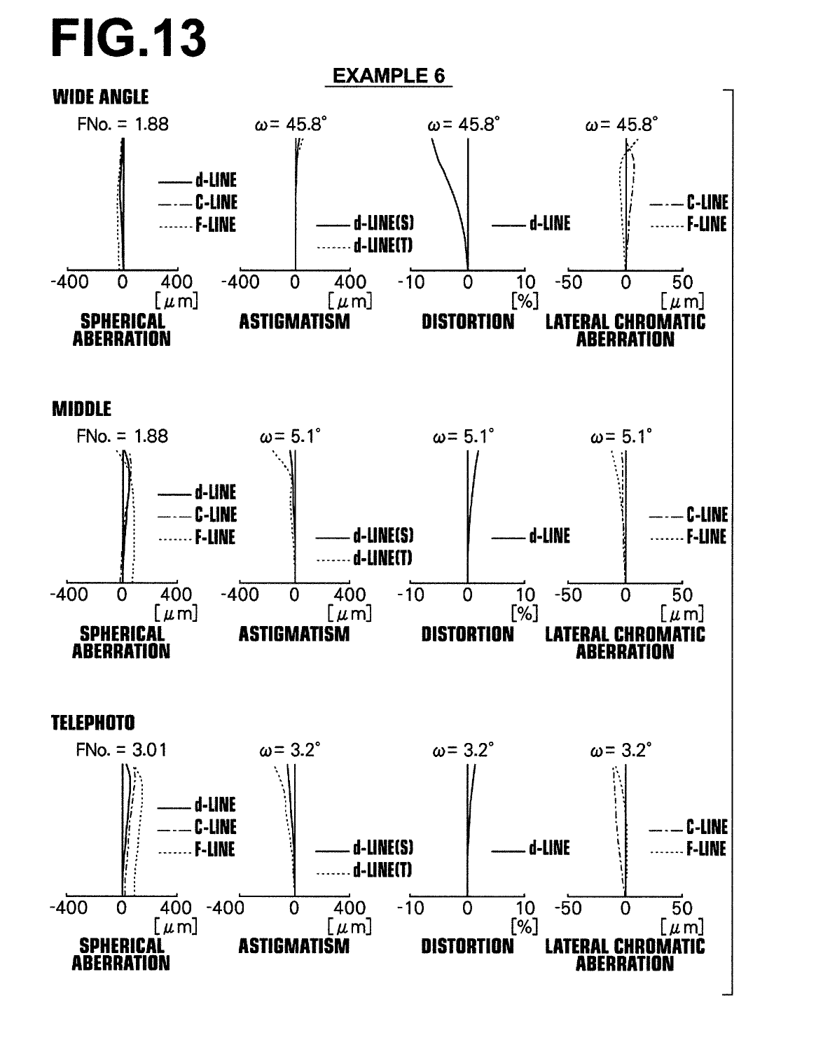

Next, a zoom lens in Example 6 will be described. FIG. 7 is a cross section illustrating the lens configuration of the zoom lens in Example 6. Further, Table 21 shows basic lens data of the zoom lens in Example 6. Table 22 shows data about the specification of the zoom lens in Example 6. Table 23 shows data about moving surface distances. Table 24 shows data about aspheric coefficients. FIG. 13 illustrates aberration diagrams.

TABLE 21
EXAMPLE 6•LENS DATA

| SURFACE | CURVATURE | SURFACE | | | |
|---|---|---|---|---|---|
| NUMBER | RADIUS | DISTANCE | nd | νd | θg, f |
| *1 | 251.3583 | 2.400 | 1.53389 | 55.98 | 0.56298 |
| 2 | 35.8557 | 14.616 | | | |
| 3 | 85.3026 | 4.007 | 1.53389 | 55.98 | 0.56298 |
| 4 | 142.0971 | 13.472 | | | |
| 5 | −54.9570 | 2.400 | 1.91082 | 35.25 | 0.58224 |
| 6 | −1048.0668 | 0.200 | | | |
| *7 | 155.5105 | 3.576 | 1.53389 | 55.98 | 0.56298 |
| 8 | 255.4287 | 0.200 | | | |
| 9 | 126.7412 | 8.200 | 1.43387 | 95.20 | 0.53733 |
| 10 | −232.0772 | 0.200 | | | |
| 11 | 81.6118 | 2.400 | 1.83481 | 42.73 | 0.56486 |
| 12 | 53.0816 | 14.284 | 1.43875 | 94.93 | 0.53433 |
| 13 | −365.4089 | 4.469 | | | |
| 14 | 55.9821 | 14.051 | 1.43387 | 95.20 | 0.53733 |
| 15 | −146.2167 | 0.200 | | | |
| *16 | 64.9845 | 5.590 | 1.78590 | 44.20 | 0.56317 |
| 17 | 466.1114 | DD[17] | | | |
| *18 | 43.1056 | 0.800 | 2.08027 | 19.18 | 0.64259 |
| 19 | 16.0659 | DD[19] | | | |
| 20 | 72.1473 | 0.800 | 1.52798 | 49.76 | 0.55950 |
| 21 | 105.0108 | 2.897 | | | |
| 22 | −19.6669 | 1.564 | 1.58887 | 47.51 | 0.56472 |
| 23 | −15.5639 | 0.800 | 1.85797 | 42.20 | 0.56333 |
| 24 | 86.3232 | 2.319 | | | |
| 25 | 101.9793 | 0.826 | 1.85598 | 22.43 | 0.62189 |
| 26 | 131.7364 | 3.014 | 1.90527 | 19.74 | 0.63243 |
| 27 | −33.5912 | DD[27] | | | |
| 28 | −31.5538 | 0.810 | 1.91000 | 37.00 | 0.57597 |
| 29 | 34.8471 | 3.351 | 1.92286 | 18.90 | 0.64960 |
| 30 | −156.7962 | DD[30] | | | |
| 31(STOP) | ∞ | 1.268 | | | |
| 32 | 611.5712 | 3.589 | 1.83481 | 42.73 | 0.56486 |
| 33 | −51.8923 | 0.800 | 1.84661 | 23.78 | 0.62072 |
| 34 | −68.2365 | 0.200 | | | |
| 35 | 56.0771 | 5.904 | 1.64419 | 33.99 | 0.58890 |
| 36 | −35.0282 | 0.800 | 1.91082 | 35.25 | 0.58224 |
| 37 | −933.9419 | 32.629 | | | |
| 38 | 2329.2121 | 3.908 | 1.60235 | 61.06 | 0.54210 |
| 39 | −43.6530 | 0.200 | | | |
| 40 | 39.5634 | 11.116 | 1.49700 | 81.54 | 0.53748 |
| 41 | −32.6989 | 0.800 | 1.91001 | 37.00 | 0.57598 |
| 42 | 27.5317 | 1.421 | | | |
| 43 | 33.4240 | 7.368 | 1.58913 | 61.14 | 0.54067 |
| 44 | −23.8165 | 0.800 | 1.91000 | 33.19 | 0.58848 |
| 45 | −111.4588 | 0.200 | | | |
| 46 | 57.8968 | 5.989 | 1.53174 | 63.78 | 0.53937 |
| 47 | −33.9490 | 0.120 | | | |
| 48 | ∞ | 1.000 | 1.51633 | 64.14 | 0.53531 |
| 49 | ∞ | 0.000 | | | |
| 50 | ∞ | 33.000 | 1.60859 | 46.44 | 0.56664 |
| 51 | ∞ | 13.200 | 1.51633 | 64.10 | 0.53463 |
| 52 | ∞ | 7.810 | | | |

TABLE 22
EXAMPLE 6•SPECIFICATION (d-LINE)

| | WIDE | | |
|---|---|---|---|
| | ANGLE | MIDDLE | TELEPHOTO |
| ZOOM RATIO | 1.00 | 10.63 | 17.19 |
| f | 5.71 | 60.65 | 98.09 |
| Bf | 37.03 | 37.03 | 37.03 |
| FNo. | 1.88 | 1.88 | 3.01 |
| MAXIMUM IMAGE HEIGHT | 5.50 | 5.50 | 5.50 |
| 2ω[°] | 91.6 | 10.2 | 6.4 |

TABLE 23
EXAMPLE 6•ZOOM DISTANCE

| | WIDE | | |
|---|---|---|---|
| | ANGLE | MIDDLE | TELEPHOTO |
| DD[17] | 0.200 | 43.468 | 45.898 |
| DD[19] | 5.530 | 7.107 | 6.541 |
| DD[27] | 39.453 | 2.858 | 10.824 |
| DD[30] | 19.364 | 11.114 | 1.283 |

TABLE 24
EXAMPLE 6•ASPHERIC COEFFICIENTS

| SURFACE NUMBER | 1 | 16 | 18 |
|---|---|---|---|
| KA | 1.4090998E+01 | 1.0456817E+00 | 1.0399885E+00 |
| A3 | −1.5552653E−06 | 3.8532629E−07 | −5.3887865E−06 |
| A4 | 1.5598684E−06 | −1.6457038E−06 | 8.0770337E−06 |
| A5 | −1.5094669E−08 | 9.5733728E−10 | −5.5619786E−08 |
| A6 | −6.2047883E−10 | −3.3319152E−10 | 1.5148431E−08 |
| A7 | 2.2183655E−11 | −2.1830153E−12 | −6.3815953E−09 |
| A8 | 1.5398542E−13 | −1.2115362E−13 | 6.9304147E−10 |
| A9 | −3.1210183E−15 | 1.7696445E−15 | 2.8631115E−11 |
| A10 | −8.6532324E−17 | 4.5198073E−17 | −7.3563482E−12 |
| A11 | −7.1953890E−18 | 3.1046386E−19 | 4.1615391E−13 |
| A12 | −3.3313726E−20 | −9.9926736E−20 | −4.6927101E−14 |
| A13 | 4.1319694E−21 | −1.0750076E−21 | −8.0206591E−16 |
| A14 | 5.8942332E−23 | −1.7682068E−23 | 9.4665669E−16 |
| A15 | 2.5371146E−24 | −5.8128421E−24 | −3.1752281E−17 |
| A16 | 1.4099923E−26 | 7.4013111E−25 | −4.4673226E−18 |
| A17 | −4.2749257E−27 | −1.5257543E−26 | 2.7634737E−19 |
| A18 | −4.4331901E−29 | −6.9775056E−29 | −4.1839756E−20 |
| A19 | 3.4911946E−30 | −5.6063301E−31 | 5.4359411E−21 |
| A20 | −3.2556970E−32 | 9.0219443E−32 | −1.9477063E−22 |

| SURFACE NUMBER | 7 |
|---|---|
| KA | 1.2543110E+00 |
| A4 | 1.0318484E−06 |
| A6 | −2.5983783E−10 |
| A8 | −1.5152593E−13 |
| A10 | 3.6154006E−16 |
| A12 | −1.5626411E−19 |
| A14 | −2.5611393E−22 |
| A16 | 2.8741892E−25 |
| A18 | 1.9663302E−29 |
| A20 | −7.9766674E−32 |

Table 25 shows values corresponding to conditional expressions (1) through (6) in Examples 1 through 6. In all of the examples, d-line is a reference wavelength, and the following Table 25 shows values at the reference wavelength.

TABLE 25

| | | LOWER LIMIT | UPPER LIMIT | | | | | | |
|---|---|---|---|---|---|---|---|---|---|
| EX- | CON- | OF | OF | EXAMPLE | EXAMPLE | EXAMPLE | EXAMPLE | EXAMPLE | EXAMPLE |
| PRESSION | DITIONAL | EXPRESSION | EXPRESSION | 1 | 2 | 3 | 4 | 5 | 6 |
| (1) | f12/f13 | 2.10 | 4.10 | 3.071 | 2.774 | 3.522 | 3.003 | 3.509 | 2.203 |
| (2) | f13/f1 | 1.00 | 1.50 | 1.279 | 1.266 | 1.224 | 1.277 | 1.226 | 1.242 |
| (3) | Z2/f1 | 0.90 | 1.40 | 1.137 | 1.183 | 1.127 | 1.123 | 1.126 | 1.147 |
| (4) | f11/f13 | −1.30 | −0.68 | −0.951 | −0.874 | −0.907 | −0.936 | −0.907 | −0.791 |
| (5) | f11/f1 | −1.23 | −0.80 | −1.217 | −1.107 | −1.110 | −1.194 | −1.112 | −0.983 |
| (6) | f1/Yimg | 5.10 | 10.00 | 6.830 | 7.145 | 7.012 | 6.525 | 6.997 | 7.244 |

As these data show, all of the zoom lenses in Example 1 through 6 satisfy conditional expressions (1) through (6). The zoom lenses are high-performance zoom lenses having wide angles of view and high magnification ratios while the size of the zoom lenses is small and the weight of the zoom lenses is light.

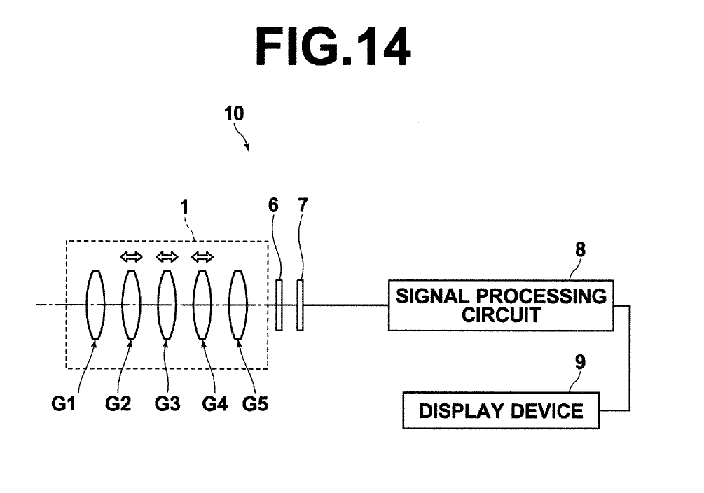

Next, an imaging apparatus according to an embodiment of the present invention will be described. FIG. 14 is a schematic diagram illustrating the configuration of an imaging apparatus using a zoom lens according to an embodiment of the present invention, as an example of an imaging apparatus according to an embodiment of the present invention. In FIG. 14, each lens group is schematically illustrated. This imaging apparatus is, for example, a video camera, an electronic still camera or the like using a solid state imaging device, such as a CCD and a CMOS, as a recording medium.

An imaging apparatus 10 illustrated in FIG. 14 includes a zoom lens 1, a filter 6 having a function of a low-pass filter or the like, and which is arranged toward the image side of the zoom lens 1, an imaging device 7 arranged toward the image side of the filter 6, and a signal processing circuit 8. The imaging device 7 converts an optical image formed by the zoom lens 1 into electrical signals. For example, a CCD (Charge Coupled Device), a CMOS (Complementary Metal Oxide Semiconductor) or the like may be used as the imaging device 7. The imaging device 7 is arranged in such a manner that an imaging surface of the imaging device 7 is matched with the image plane of the zoom lens 1.

An image imaged by the zoom lens 1 is formed on the imaging surface of the imaging device 7, and signals about the image are output from the imaging device 7. Operation processing is performed on the output signals at a signal processing circuit 8, and an image is displayed on a display device 9.

So far, the present invention has been described by using embodiments and examples. However, the present invention is not limited to the aforementioned embodiments nor examples, and various modifications are possible. For example, the values of the curvature radius, a distance between surfaces, a refractive index, an Abbe number and the like of lens elements are not limited to the values in the aforementioned numerical value examples, and may be other values.

What is claimed is:

1. A zoom lens essentially consisting of:
a first lens group having positive refractive power;
a second lens group having negative refractive power;
a third lens group having negative refractive power;
a fourth lens group having negative refractive power; and
a fifth lens group having positive refractive power in this order from an object side,
wherein the first lens group and the fifth lens group are fixed with respect to an image plane, and the second lens group, the third lens group and the fourth lens group move in such a manner that a distance from each other changes when magnification is changed from a wide angle end to a telephoto end, and
wherein the first lens group essentially consists of an 11th lens group having negative refractive power, a 12th lens group having positive refractive power, and a 13th lens group having positive refractive power in this order from the object side, and wherein the 11th lens group and the 13th lens group are fixed with respect to the image plane and the 12th lens group moves during focusing, and
wherein the following conditional expression (1) is satisfied:
2.10<f12/f13<4.10 (1), where
f12: a focal length of the 12th lens group, and
f13: a focal length of the 13th lens group.

2. The zoom lens, as defined in claim 1, wherein the following conditional expression (2) is satisfied:
1.00<f13/f1<1.50 (2), where
f1: a focal length of the first lens group.

3. The zoom lens, as defined in claim 1, wherein the following conditional expression (3) is satisfied:
0.90<Z2/f1<1.40 (3), where
Z2: a movement amount of the second lens group from a wide angle end to a telephoto end, and
f1: a focal length of the first lens group.

4. The zoom lens, as defined in claim 1, wherein the following conditional expression (4) is satisfied:
−1.30<f11/f13<−0.68 (4), where
f11: a focal length of the 11th lens group.

5. The zoom lens, as defined in claim 1, wherein the following conditional expression (5) is satisfied:
−1.23<f11/f1<−0.80 (5), where
f11: a focal length of the 11th lens group, and
f1: a focal length of the first lens group.

6. The zoom lens, as defined in claim 1, wherein the following conditional expression (6) is satisfied:
5.10<f1/Yimg<10.00 (6), where
f1: a focal length of the first lens group, and
Yimg: a maximum image height.

7. The zoom lens, as defined in claim 1, wherein the following conditional expression (1-1) is satisfied:
2.20<f12/f13<3.80 (1-1).

8. The zoom lens, as defined in claim 1, wherein the following conditional expression (2-1) is satisfied:
1.20<f13/f1<1.50 (2-1), where
f1: a focal length of the first lens group.

9. The zoom lens, as defined in claim 1, wherein the following conditional expression (2-2) is satisfied:
1.20<f13/f1<1.30 (2-2), where
f1: a focal length of the first lens group.

10. The zoom lens, as defined in claim 1, wherein the following conditional expression (3-1) is satisfied:
1.10<Z2/f1<1.20 (3-1), where
Z2: a movement amount of the second lens group from a wide angle end to a telephoto end, and
f1: a focal length of the first lens group.

11. The zoom lens, as defined in claim 1, wherein the following conditional expression (4-1) is satisfied:
−1.00<f11/f13<−0.70 (4-1), where
f11: a focal length of the 11th lens group.

12. The zoom lens, as defined in claim 1, wherein the following conditional expression (5-1) is satisfied:
−1.22<f11/f1<−0.90 (5-1), where
f11: a focal length of the 11th lens group, and
f1: a focal length of the first lens group.

13. The zoom lens, as defined in claim 1, wherein the following conditional expression (6-1) is satisfied:
6.10<f1/Yimg<10.00 (6-1), where
f1: a focal length of the first lens group, and
Yimg: a maximum image height.

14. The zoom lens, as defined in claim 1, wherein the following conditional expression (6-2) is satisfied:
6.40<f1/Yimg<7.50 (6-2), where
f1: a focal length of the first lens group, and
Yimg: a maximum image height.

15. An imaging apparatus comprising:
the zoom lens, as defined in claim 1.
